(19) United States
(12) Patent Application Publication
(10) Pub. No.: US 2025/0239764 A1
(43) Pub. Date: Jul. 24, 2025

(54) MODULAR MULTIBAND BASE STATION ANTENNAS HAVING CAVITY PHASE SHIFTER ASSEMBLIES

(71) Applicant: Outdoor Wireless Networks LLC, Claremont, NC (US)

(72) Inventors: Ligang Wu, Suzhou (CN); Fusheng Lv, Suzhou (CN); Zhanming Zhang, Suzhou (CN); Fan He, Suzhou (CN); Qingju Hua, Suzhou (CN); Cheng Xue, Suzhou (CN); Changfu Chen, Suzhou (CN); Bin Sun, Suzhou (CN); Pengfei Guo, Suzhou (CN); YueMin Li, Suzhou (CN); Jian Zhang, Suzhou (CN); Peng Xiao, Suzhou (CN); Jun Sun, Suzhou (CN); HanXing Xu, Suzhou (CN)

(21) Appl. No.: 18/954,975

(22) Filed: Nov. 21, 2024

(30) Foreign Application Priority Data
Jan. 24, 2024 (CN) 202410053747.7
May 15, 2024 (CN) 202410605639.6

(51) Int. Cl. H01Q 3/36; H01Q 1/24; H01Q 1/50; H01Q 9/28; H01Q 19/10

(52) U.S. Cl. CPC H01Q 3/36; H01Q 1/246; H01Q 1/50; H01Q 9/28; H01Q 19/104

(57) ABSTRACT

A base station antenna comprises a reflector; a phase shifter that includes a phase shifter printed circuit board; and a radiating element that includes at least one feed stalk and a radiator mounted on the feed stalk forwardly of the reflector. The feed stalk is mounted directly on the phase shifter printed circuit board.

### CROSS-REFERENCE TO RELATED APPLICATIONS

The present application claims priority to Chinese Patent Application No. 202410605639.6, filed May 15, 2024 and to Chinese Patent Application No. 202410053747.7, filed Jan. 12, 2024, the entire content of each of which is incorporated herein by reference.

### FIELD

The present disclosure relates to communications systems and, in particular, to base station antennas for cellular communications systems.

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally to narrow the beamwidths of the generated antenna beams in the azimuth (horizontal) plane. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to be connected to a pair of radios (or radio ports of a single radio) so that the linear array can transmit and receive RF signals at two orthogonal polarizations (i.e., an antenna beam is generated at each orthogonal polarization).

Each of the above-described linear arrays of dual-polarized radiating elements is coupled to two ports of a radio (one port for each polarization). An RF signal that is to be transmitted by the linear array is passed from the radio to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a 120° sector of a cell. Typically these linear arrays will have remote electronic tilt (“RET”) capabilities which allow a cellular operator to change, from a control center, the pointing angle of the generated antenna beams in the elevation (vertical) plane in order to change the size of the sector served by the linear array (since the more that the antenna beam is downtilted in the elevation plane, the less the area that is illuminated by the antenna beam, and hence the smaller the size of the area covered by the antenna beam). Since the antenna beams generated by the above-described 2G/3G/4G linear arrays are static antenna beams that only change in shape due to adjustments in the downtilt angle of the antenna beam, they are often referred to as “passive” linear arrays.

Cellular operators are currently upgrading their networks to support fifth generation (“5G”) cellular service. One important component of 5G cellular service is the use of multi-column “active” beamforming arrays that operate in conjunction with beamforming radios. The beamforming radios change the amplitudes and/or phases of the sub-components of a signal that is to be transmitted. The sub-components of the signal are passed to respective subsets of the radiating elements of the active beamforming array in order to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz and/or the 5.1-5.8 GHz frequency bands, although active beamforming radios may also be provided that operate in other frequency bands such as the upper portion (e.g., 2.5-2.7 GHz) of the mid-band frequency range. The radiating elements in each vertically-extending column of such an active beamforming array are typically coupled to a respective port of a beamforming radio so that each column of radiating elements is fed a different sub-component of the signal to be transmitted. The beamforming radio may be a separate device, or may be integrated with the active antenna array. As discussed above, the beamforming radio may adjust the amplitudes and phases of the sub-components of an RF signal that are fed to each port of the radio (and hence to each respective column of radiating elements in the multi-column beamforming array) in order to generate antenna beams that have narrowed beamwidths in the azimuth plane (and hence higher antenna gain). These narrowed antenna beams can be electronically steered throughout the sector by proper selection of the amplitudes and phases of the sub-components of the RF signal. In order to avoid having to increase the number of antennas at cell sites, 5G antennas that include such beamforming arrays also often include passive linear arrays that support legacy 2G, 3G and/or 4G cellular services.

Pursuant to embodiments of the present invention, base station antennas are provided that comprise a reflector; a phase shifter that includes a phase shifter printed circuit board; and a radiating element that includes at least one feed stalk and a radiator mounted on the feed stalk forwardly of the reflector. The feed stalk is mounted directly on the phase shifter printed circuit board.

In some embodiments, the phase shifter printed circuit board is mounted rearwardly of the reflector. In some embodiments, the reflector includes an opening and the feed stalk extends through the opening. In some embodiments, the radiating element is a dual-polarized radiating element, the radiator is a first radiator and the radiating element includes a second radiator, and the feed stalk is implemented using a single printed circuit board that includes first and second RF transmission lines that feed the respective first and second radiators. In some embodiments, the radiator comprises a printed circuit board that includes first and second metal pads and a pair of sheet metal dipole arms that are configured to capacitively couple with the respective first and second metal pads. In some embodiments, the opening in the reflector is larger than the printed circuit board so that the printed circuit board can be passed through the opening.

In some embodiments, the phase shifter is part of a cavity phase shifter assembly that further includes a metal shell and the phase shifter printed circuit board is mounted within the metal shell. In some embodiments, the feed stalk includes a slot and the phase shifter printed circuit board extends into the slot. In some embodiments, the feed stalk is mounted on the phase shifter printed circuit board adjacent an output on the phase shifter printed circuit board, and a solder joint electrically connects the output to a signal trace on the feed stalk. In some embodiments, a ground pin extends forwardly from the metal shell, and the ground pin is soldered to a ground conductor on the feed stalk. In some embodiments, a solderable metal coating is selectively formed on the ground pin. In some embodiments, the metal shell includes a forwardly extending protrusion that defines an internal channel, and the phase shifter printed circuit board is received within the internal channel. In some embodiments, the forwardly extending protrusion includes a gap that exposes the phase shifter printed circuit board, and the feed stalk is mounted on the phase shifter printed circuit board within the gap. In some embodiments, a ground pin extends forwardly from the metal shell within the gap, and a profile of the ground pin matches a profile of at least a portion of the forwardly extending protrusion.

In some embodiments, a front wall of the metal shell includes an opening, and the feed stalk extends through the opening. In some embodiments, a side wall of the metal shell includes a window that is aligned with the opening in the front wall of the metal shell. In some embodiments, the feed stalk extends into a cavity within the metal shell and is mounted on the phase shifter printed circuit board within the cavity. In some embodiments, a galvanic connection is provided between a ground conductor on the feed board and the metal shell.

Pursuant to further embodiments of the present invention, base station antennas are provided that comprise a reflector having an opening; and a radiating element that includes a feed stalk and a printed circuit board that is mounted adjacent a forward end of the feed stalk, the printed circuit board extending perpendicular to the feed stalk. A footprint of the opening is larger than a footprint of the printed circuit board and the opening is aligned with the printed circuit board.

In some embodiments, the printed circuit board includes first through fourth metal pads, the radiating element further comprising first through fourth sheet metal dipole arms that are mounted on the printed circuit board and configured to capacitively couple with the respective first through fourth metal pads. In some embodiments, a footprint of the first through fourth sheet metal dipole arms is larger than the footprint of the opening. In some embodiments, the base station antenna further comprises a cavity phase shifter assembly mounted rearwardly of the reflector, the cavity phase shifter including a metal shell and a phase shifter printed circuit board that is mounted within the metal shell. In some embodiments, a ground conductor on the feed stalk is galvanically connected to the metal shell. In some embodiments, the feed stalk extends into a cavity within the metal shell and electrically connects to the phase shifter printed circuit board within the cavity. In some embodiments, the metal shell includes a forwardly extending ground pin that is soldered to the feed stalk.

Pursuant to additional embodiments of the present invention, methods of assembling a base station antenna are provided that comprise forming a metal shell of a cavity phase shifter assembly; installing a phase shifter within the metal shell; mounting feed stalks for a plurality of radiating elements on the cavity phase shifter assembly; and then mounting the cavity phase shifter assembly with the feed stalks mounted thereon behind a reflector with the feed stalks extending through respective openings in the reflector; and then mounting radiators on the respective feed stalks.

In some embodiments, the method further comprises mounting respective printed circuit boards that each include a plurality of metal pads on the respective feed stalks prior to mounting the cavity phase shifter assembly with the feed stalks mounted thereon behind the reflector and mounting a plurality of sheet metal dipole arms on each printed circuit board after mounting the cavity phase shifter assembly with the feed stalks mounted thereon behind the reflector.

In some embodiments, footprints of the openings in the reflector are larger than footprints of the printed circuit boards and the openings are aligned with the printed circuit boards.

In some embodiments, the method further comprises galvanically connecting a ground conductor on each feed stalk to the metal shell. In some embodiments, the metal shell includes a plurality of forwardly-extending ground pins, and the ground conductors on each feed stalk are soldered to the respective ground pins.

Pursuant to yet additional embodiments of the present invention, base station antennas are provided that comprise a composite metal shell that includes a plurality of pairs of cavities; a plurality of phase shifter printed circuit boards mounted within the respective cavities; and a calibration printed circuit board mounted on the composite metal shell and electrically connected to each of the phase shifter printed circuit boards through a plurality of metal pins.

In some embodiments, a ground conductor on the calibration printed circuit board is galvanically connected to the composite metal shell.

In some embodiments, the composite metal shell includes a plurality of rearwardly-extending metal ground pins that are received within respective holes in the calibration printed circuit board.

In some embodiments, the base station antenna further comprises a plurality of metal ground pins that are interference fit within respective holes in the composite metal shell. In some embodiments, at least some of the metal ground pins include a solderable metal coating.

In some embodiments, the base station antenna further comprises a plurality of metal ground pin blocks that are affixed to the composite metal shell, each metal ground pin block including one or more rearwardly-extending metal ground pins. In some embodiments, the metal ground pin blocks include a solderable metal coating. In some embodiments, the metal ground pins are soldered to respective metal pads on the calibration printed circuit board.

In some embodiments, the base station antenna further comprises a plurality of metal isolation pins that are received within respective holes in the calibration printed circuit board and extend rearwardly from the calibration printed circuit board. In some embodiments, the metal isolation pins are interference fit within respective holes in the composite metal shell. In some embodiments, each metal isolation pin includes a solderable metal coating.

In some embodiments, each of the cavities includes a window in a sidewall of the cavity, the window positioned adjacent a respective one of the metal pins.

In some embodiments, a first end of each metal pin is soldered to a metal pad on a respective one of the phase shifter printed circuit boards and a second end of each metal pin is received within a respective hole in the calibration printed circuit board.

In some embodiments, a pair of ground pins are provided on opposed sides of each metal pin

Pursuant to still further embodiments of the present invention, base station antennas are provided that comprise a cavity phase shifter assembly that includes a metal shell having a front wall, where a plurality of cavities are formed within the metal shell; a plurality of phase shifter printed circuit boards mounted within the respective cavities; and a plurality radiating elements that are arranged to form a plurality of columns of radiating elements, where each radiating element is mounted to extend forwardly from the metal shell. A plurality of metal ground pins extend forwardly from the front wall of the metal shell and are galvanically connected to the respective radiating elements.

In some embodiments, each radiating element is mounted on a respective feed board printed circuit board, and the metal ground pins are galvanically connected to a ground plane on the feed board printed circuit board via solder joints. In some embodiments, each metal ground pin includes a solderable metal coating. In some embodiments, the metal ground pins are interference fit within respective holes in the metal shell.

In some embodiments, the base station antenna further comprises a metal ground pin block that is affixed to the metal shell, the metal ground pin block including one or more rearwardly-extending metal ground pins. In some embodiments, the metal ground pin block includes a solderable metal coating.

Pursuant to still other embodiments of the present invention, base station antennas are provided that comprise a coaxial cable and a cavity phase shifter assembly that includes a metal shell having a front wall, the metal shell defining an internal cavity; a phase shifter printed circuit board mounted within the internal cavity; and a separate solderable metal element mounted on the metal shell and soldered to an outer conductor of the coaxial cable. The metal shell includes a window that exposes the phase shifter printed circuit board, and a center conductor of the coaxial cable extends through the window and is soldered to the phase shifter printed circuit board.

In some embodiments, the separate solderable metal element mounted on the metal shell comprises a ground pin that is interference fit within a hole in the metal shell. In some embodiments, the separate solderable metal element mounted on the metal shell comprises at least first and second metal ground pins that are interference fit within respective first and second holes in the metal shell, wherein the coaxial cable is received between the first and second metal ground pins. In some embodiments, each of the first and second metal ground pins includes a solderable metal coating.

In some embodiments, the separate solderable metal element mounted on the metal shell comprises a metal ground block that is affixed the metal shell. In some embodiments, the metal ground block is affixed the metal shell by soldering or welding. In some embodiments, the metal ground block includes a cable receiving portion that is shaped to receive a coaxial cable.

Pursuant to yet additional embodiments of the present invention, base station antennas are provided that comprise a cavity phase shifter assembly that includes a metal shell that has at least a first cavity formed therein and a cross-dipole radiating element that includes a feed stalk, the cross-dipole radiating element mounted to extend forwardly from the metal shell. The cross-dipole radiating element is mounted on the metal shell using connectors that extend through a first element of the feed stalk.

In some embodiments, the cross-dipole radiating element further comprises a first dipole radiator having a first longitudinal axis that extends in a first direction and a second dipole radiator having a second longitudinal axis that extends in a second direction that is perpendicular to the first direction. In some embodiments, the first element of the feed stalk comprises a first feed stalk printed circuit board. In some embodiments, the feed stalk further comprises a second feed stalk printed circuit board that is mounted on the metal shell and that extends parallel to the first feed stalk printed circuit board. In some embodiments, the metal shell comprises a front wall and a first tab that extends forwardly from the front wall, and wherein the connectors extend through respective openings in the first tab. In some embodiments, the metal shell comprises a front wall and first and second tabs that extend forwardly from the front wall, and wherein the first feed stalk printed circuit board is mounted on the first tab and the second feed stalk printed circuit board that is mounted on the second tab.

In some embodiments, the first cavity is one of a plurality of cavities included in the metal shell, the cavity phase shifter assembly further including a plurality of phase shifter printed circuit boards mounted within the respective cavities. In some embodiments, a signal trace on the first feed stalk printed circuit board is directly soldered to an output trace on a first of the phase shifter printed circuit boards, and a ground trace on the first feed stalk printed circuit board is capacitively coupled to the metal shell. In some embodiments, the first feed stalk printed circuit board is mounted forwardly of and is aligned with a first of the phase shifter printed circuit boards, and the second feed stalk printed circuit board is mounted forwardly of and is aligned with a second of the phase shifter printed circuit boards.

In some embodiments, the connectors comprise rivets.

In some embodiments, the cross-dipole radiating element comprises a dipole radiator printed circuit board having a first surface that includes first through fourth metal pads and wherein the cross-dipole radiating element comprises first through fourth dipole arms that overlap the respective first through fourth metal pads to form first through fourth capacitors. In some embodiments, the dipole radiator printed circuit board further includes first through fourth inductors that are coupled to the respective first through fourth dipole arms. In some embodiments, the feed stalk includes first and second signal traces and first and second ground traces, and the first through fourth capacitors and the first through fourth inductors are configured as first through fourth inductor-capacitor circuits that couple the first and second signal traces and first and second ground traces to the respective dipole arms.

In some embodiments, the first through fourth dipole arms are formed on a second surface of the dipole radiator printed circuit board. In some embodiments, the first through fourth dipole arms are first through fourth sheet metal dipole arms that are attached to the dipole radiator printed circuit board.

Pursuant to still other embodiments of the present invention, base station antennas are provided that comprise a cavity phase shifter assembly that includes a metal shell that has at least a first cavity formed therein and a cross-dipole radiating element that includes a first feed stalk printed circuit board, the cross-dipole radiating element mounted to extend forwardly from the metal shell so that a major surface of the first feed stalk printed circuit board extends in parallel to a sidewall of the metal shell.

In some embodiments, the cross-dipole radiating element further includes a second feed stalk printed circuit board that extends in parallel to the sidewall of the metal shell.

In some embodiments, the cross-dipole radiating element is mounted on the metal shell at least one connector that extends through the first feed stalk printed circuit board. In some embodiments, the metal shell comprises a front wall and a first tab that extends forwardly from the front wall, and wherein the at least one connector extends through an opening in the first tab. In some embodiments, the metal shell comprises a front wall and first and second tabs that extend forwardly from the front wall, and wherein the first feed stalk printed circuit board is mounted on the first tab and the second feed stalk printed circuit board that is mounted on the second tab.

In some embodiments, the cross-dipole radiating element comprises a dipole radiator printed circuit board having a first surface that includes first through fourth metal pads and wherein the cross-dipole radiating element comprises first through fourth dipole arms that overlap the respective first through fourth metal pads to form first through fourth capacitors. In some embodiments, the dipole radiator printed circuit board further includes first through fourth inductors that are coupled to the respective first through fourth dipole arms. In some embodiments, the feed stalk includes first and second signal traces and first and second ground traces, and the first through fourth capacitors and the first through fourth inductors are configured as first through fourth inductor-capacitor circuits that couple the first and second signal traces and first and second ground traces to the respective dipole arms. In some embodiments, the first through fourth dipole arms are formed on a second surface of the dipole radiator printed circuit board.

### BRIEF DESCRIPTION OF THE DRAWINGS

FIG. 1A is a front perspective view of a conventional base station antenna that includes both passive 2G/3G/4G linear arrays and an active beamforming array.

FIG. 1B is a schematic front view of the conventional base station antenna of FIG. 1A with the radome removed.

FIG. 2 is a schematic exploded side perspective view of certain components of a modular multiband base station antenna according to embodiments of the present invention.

FIG. 3A is a schematic side perspective view of a representative portion of a low-band linear array assembly that may be used to implement the low-band linear array assemblies included in the base station antenna of FIG. 2.

FIG. 3B is a schematic end view of a cavity phase shifter assembly that is included in the low-band linear array assembly of FIG. 3A.

FIG. 3C is an enlarged schematic rear perspective view of a small portion of the cavity phase shifter assembly of FIG. 3B that illustrates how a pair of RF feed cables connect to the cavity phase shifter assembly.

FIG. 3D is an enlarged schematic rear perspective view of a portion of another cavity phase shifter assembly that can be used in place of the cavity phase shifter assembly of FIG. 3C.

FIG. 4A is a schematic side perspective view of a mid-band linear array assembly that may be used to implement the mid-band linear array assemblies of the base station antenna of FIG. 2.

FIG. 4B is an enlarged schematic perspective view of a small portion of the mid-band linear array assembly of FIG. 4A with a callout that illustrates how the feed stalks of the mid-band radiating elements are mounted on a cavity phase shifter assembly of the mid-band linear array assembly.

FIG. 4C is an enlarged schematic perspective view of a portion of an alternative mid-band linear array assembly that can be used in the base station antenna of FIG. 2 instead of the mid-band linear array assembly of FIGS. 4A-4B. The callout in FIG. 4C illustrates how the feed stalks of the mid-band radiating elements are mounted on a cavity phase shifter assembly of the alternative mid-band linear array assembly.

FIG. 4D is an enlarged schematic perspective view of the mid-band radiating element illustrated in FIG. 4C that illustrates how the radiating element can be assembled through a reflector of the base station antenna of FIG. 2.

FIG. 5A is a schematic side perspective view of a high-band multi-column array assembly that may be used to implement the high-band multi-column array assembly of the base station antenna of FIG. 2.

FIG. 5B is an exploded schematic rear perspective view illustrating the connection between a calibration printed circuit board and a composite metal shell of the high-band multi-column array assembly of FIG. 5A.

FIG. 5C is a pair of schematic perspective views of a portion of the composite metal shell of the high-band multi-column array assembly of FIG. 5A that illustrates one method of forming ground pins on the composite metal shell.

FIGS. 6A and 6B are an enlarged schematic front perspective view and an exploded front perspective view, respectively, illustrating how the high-band radiating elements can be mounted on the composite metal shell of the high-band multi-column array assembly of FIGS. 5A-5B via a galvanic ground connection.

FIGS. 7A and 7B are exploded schematic rear perspective views that illustrate a connection according to further embodiments of the present invention between the calibration printed circuit board and the composite metal shell of the high-band multi-column array assembly of FIG. 5A.

FIGS. 8A and 8B are an exploded rear perspective view and a rear perspective view, respectively, that illustrate a connection according to additional embodiments of the present invention between the calibration printed circuit board and the composite metal shell of the high-band multi-column array assembly of FIG. 5A.

FIGS. 9A and 9B are a rear perspective view and an exploded rear perspective view, respectively, that illustrate how isolation pins may be mounted in the calibration printed circuit board and/or the composite metal shell of the high-band multi-column array assembly of FIG. 5A in order to improve isolation between selected of the input ports on the calibration printed circuit board.

FIG. 10A is an enlarged schematic rear perspective view of a small portion of a modified version of one of the cavity phase shifter assemblies of FIG. 2 that illustrates a cable block that may be welded or laser soldered to the cavity phase shifter assembly.

FIG. 10B is a schematic rear perspective view of a portion of the cavity phase shifter assembly shown in FIG. 10A with a pair of RF feed cables mounted in the cable block.

FIG. 11 is an enlarged schematic rear perspective view of a small portion of another modified version of one of the cavity phase shifter assemblies of FIG. 2 that illustrates how grounding pins may be used to connect a pair of RF feed cables to the cavity phase shifter assembly.

FIGS. 12A and 12B are enlarged schematic exploded front perspective views illustrating how the high-band radiating elements can be galvanically connected to the composite metal shell of the high-band multi-column array assembly of FIGS. 5A-5B using an interference fit grounding block or interference fit grounding pins.

FIG. 13A is a schematic side view with a perspective callout illustrating another mid-band linear array assembly according to embodiments of the present invention that may be used to implement the mid-band linear array assemblies of the base station antenna of FIG. 2.

FIG. 13B is an enlarged schematic perspective view of a small portion of the cavity phase shifter shown in FIG. 13A before radiating elements are mounted thereon.

FIG. 13C is a schematic perspective view of one of the mid-band radiating elements shown in FIG. 13A.

FIGS. 14A and 14B are a front perspective view and an exploded front perspective view, respectively, of a small portion of a cavity phase shifter assembly of a mid-band linear array assembly according to still further embodiments of the present invention with the feed stalks of a mid-band radiating element mounted thereto.

FIG. 14C is a front perspective view of the mid-band linear array assembly of FIGS. 14A-14B with a complete mid-band radiating element 760 mounted thereon.

FIG. 15A is a front perspective view of the cavity phase shifter assembly of FIGS. 14A-14B with a different mid-band radiating element mounted thereon.

FIGS. 15B and 15C are front and rear views, respectively, of a dipole radiator printed circuit board of the mid-band radiating element shown in FIG. 15B.

FIGS. 16A and 16B are a front perspective view and an exploded front perspective view, respectively, of the cavity phase shifter assembly of FIGS. 14A-14B with a mid-band radiating element according to further embodiments of the present invention mounted thereon.

FIGS. 16C and 16D are front and rear views, respectively, of a dipole radiator printed circuit board of the mid-band radiating element of FIGS. 16A-16B.

It should be noted that herein like elements may be referred to individually by their full reference numeral and may be referred to collectively by the first part of their reference numeral.

### DETAILED DESCRIPTION

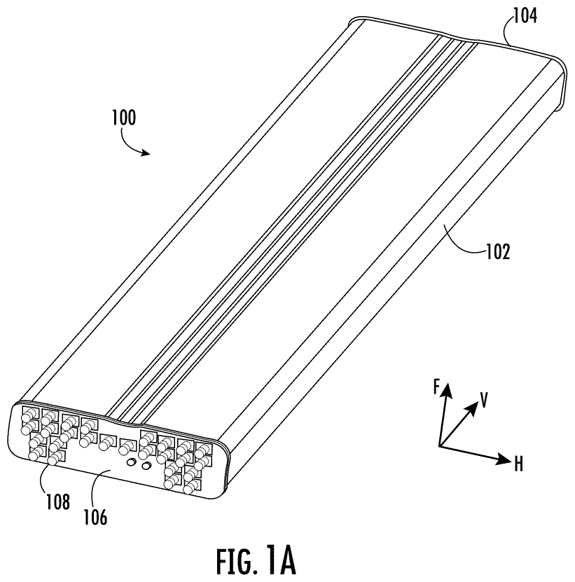

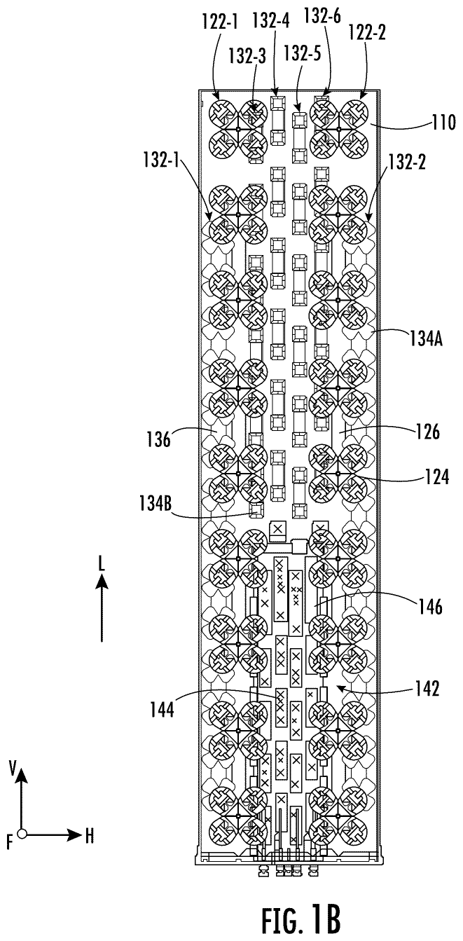

FIGS. 1A and 1B illustrate a conventional base station antenna 100 that includes both passive low-band and mid-band linear arrays and a high-band active beamforming array. In particular, FIG. 1A is a front perspective view of the base station antenna 100, and FIG. 1B is a schematic front view of the base station antenna 100 with the radome thereof removed. In FIGS. 1A and 1B, the axes illustrate the vertical (V), horizontal (H) and forward (F) directions of the base station antenna system 100. In the description that follows, each antenna will be described using terms that assume that the antenna is mounted for use on a tower with the longitudinal axis L of the antenna extending along a vertical axis and the front surface of the antenna mounted opposite the tower pointing toward the coverage area for the antenna.

Referring to FIG. 1A, the base station antenna 100 has a tubular shape with a generally rectangular cross-section. The base station antenna 100 includes a radome 102 a top end cap 104 and a bottom end cap 106. One or more mounting brackets (not shown) may be provided on the rear side of the antenna 100 which may be used to mount the antenna 100 onto an antenna mount (not shown) on, for example, an antenna tower. A plurality of RF ports 108 in the form of RF connectors are mounted in the bottom end cap 106. The RF ports 108 extend through the bottom end cap 106 and are used to electrically connect the base station antenna 100 to external radios (not shown). The radome 102, top end cap 104 and bottom cap 106 may form an external housing for the antenna 100. An antenna assembly (FIG. 1B) is contained within the housing.

FIG. 1B is a schematic front view of the antenna assembly that is contained within the housing of base station antenna 100. As shown in FIG. 1B, the antenna assembly includes a reflector 110. The reflector 110 may serve as both a structural component for the antenna assembly and as a ground plane and reflector for at least some of the radiating elements (discussed below) of antenna 100. The reflector 110 includes a generally flat metallic surface that extends in the longitudinal direction L of the antenna 100. Various mechanical and electronic components of base station antenna 100 (not shown) are mounted behind the reflector 110.

The antenna assembly further includes first and second low-band arrays 122-1, 122-2 of low-band radiating elements 124, first and second mid-band arrays 132-1, 132-2 of first mid-band radiating elements 134A, third through sixth mid-band arrays 132-3 through 132-6 of second mid-band radiating elements 134B, and a multi-column high-band array 142 of high-band radiating elements 144. The low-band arrays 122 and mid-band arrays 132 are each implemented as vertically-extending linear arrays of radiating elements. The low-band and mid-band linear arrays 122, 132 may support, for example, 2G, 3G and/or 4G cellular service. Each of the low-band and mid-band linear arrays 122, 132 are passive arrays that generate static antenna beams that provide coverage to a predefined coverage area (e.g., antenna beams that are each configured to cover a 120° sector of a base station), with the only change to the coverage area occurring when the electronic downtilt angles of the generated antenna beams are adjusted (e.g., to change the size of the cell).

The high-band radiating elements 144 are mounted in four columns in the lower center portion of the reflector 110 to form the multi-column array 142 of high-band radiating elements 144. Each column of the multi-column array 142 may be coupled to a pair of ports (one for each polarization) of a beamforming radio so that the multi-column array 142 operates as an active beamforming array that generates narrowed antenna beams that can be steered in the azimuth plane throughout the coverage area.

The low-band radiating elements 124 are configured to transmit and receive signals in the 617-960 MHz frequency range or a portion thereof (e.g., the 617-896 MHz frequency band, the 696-960 MHz frequency band, etc.). The first mid-band radiating elements 134A are configured to transmit and receive signals in the 1427-2690 MHz frequency range or a portion thereof (e.g., the 1427-1710 MHz frequency band, the 1427-2200 MHz frequency band, etc.). The second mid-band radiating elements 134B are configured to transmit and receive signals in the 1695-2690 MHz frequency range or a portion thereof (e.g., the 1710-2200 MHz frequency band, the 2300-2690 MHz frequency band, etc.). The second mid-band radiating elements 134B may have a different design than the first mid-band radiating elements 134A. The high-band radiating elements 144 are configured to transmit and receive signals in the 3300-4200 MHz frequency range or a portion thereof. The radiating elements 124, 134A, 134B, 144 are mounted to extend forwardly from the reflector 110.

The low-band and mid-band radiating elements 124, 134A, 134B may each be implemented as dual-polarized radiating elements that each include first and second radiators that are configured to transmit and receive RF energy at orthogonal polarizations. For example, the low-band and mid-band radiating elements 124, 134A, 134B may be implemented as slant −45°/+45° cross-dipole radiating element that include a −45° dipole radiator and a +45° dipole radiator that are arranged to form a cross when the radiating elements 124, 134A, 134B are viewed from the front. The dipole radiators of each low-band and mid-band radiating element 124, 134A, 134B are mounted on a feed stalk (not visible in the figures) that passes RF signals between the dipole radiators and an associated feed network.

Since dual-polarized radiating elements are used, each of the low-band and mid-band linear arrays 122, 132 are connected to a pair of the RF ports 108. The first RF port 108 of each pair is connected to a first port of a passive (non-beamforming) radio (e.g., a remote radio head mounted on the antenna tower near the base station antenna 100), typically by a coaxial cable. A feed cable and a feed network connect the first RF port 108 to the first polarization radiators of the radiating elements 124, 134A, 134B in the respective linear arrays 122, 132. Similarly, the second RF port 108 of each pair is connected to a second port of the radio by a coaxial cable and another feed cable and feed network connect the second RF port 108 to the second polarization radiators of the radiating elements 124, 134A, 134B in a respective one of the linear arrays 122, 132. RF signals that are to be transmitted by a selected one of the low-band and mid-band linear arrays 122, 132 are passed from the associated radio to one of the RF ports 108, and passed from the RF port 108 to the associated feed network. Each feed network may include a phase shifter assembly that includes a power divider that divides the RF signal into a plurality of sub-components that are fed to the respective first or second radiators of the radiating elements 124, 134A, 134B in the linear array 122, 132 so that the sub-components are radiated into free space. Accordingly, each linear array 122, 132 may be used to form a pair of antenna beams, namely an antenna beam for each of the two polarizations at which the dual-polarized radiating elements included in the respective array are designed to transmit and receive RF signals. Each linear array 122, 132 may be configured to provide service to a sector of a base station. For example, each linear array 122, 132 may be configured to provide coverage to approximately 120° in the azimuth plane so that the base station antenna 100 may act as a sector antenna for a three sector base station.

The high-band radiating elements 144 are also implemented as dual polarized slant −45°/+45° cross-dipole radiating elements. Each column of high-band radiating elements 144 is coupled to a pair of ports (one port for each polarization) of a beamforming radio (not shown) that may be, for example, mounted on the antenna tower adjacent the antenna 100. The beamforming radio is capable of electronically adjusting the amplitudes and/or phases of the subcomponents of an RF signal that are output to each column of high-band radiating elements 144 of the multi-column beamforming array 142. The beamforming radio may change the size, shape and pointing direction of the generated antenna beams by adjusting the amplitudes and/or phases of the subcomponents of an RF signal that are output to each column. These adjustments may be made, for example, on a time slot by time slot basis of a time division multiple access scheme.

As shown best in FIG. 1B, the low-band radiating elements 124 may be mounted on low-band feed board printed circuit boards 126, the mid-band radiating elements 134A, 134B may be mounted on mid-band feed board printed circuit boards 136, and the high-band radiating elements 144 may be mounted on high-band feed board printed circuit boards 146. The feed board printed circuit boards 126, 136, 146 couple RF signals between groups of one to three radiating elements 124, 134A, 134B, 144 and phase shifter assemblies that are interposed between the RF ports 108 and the arrays 122, 132, 142. Cables (not shown) may be used to connect each feed board 126, 136, 146 to the phase shifter assemblies.

While the conventional base station antenna 100 of FIGS. 1A-1B can support a wide range of communications services, in practice it can be difficult to manufacture. Cellular operators tend to have strict limitations on the acceptable physical sizes for various types of base station antennas, since the base station antennas are often mounted on tall antenna towers where they can be subject to very high wind loads. As the size of a base station antenna increases, wind-loading considerations can greatly increase the structural requirements for the antenna mounting hardware and the antenna tower, which can significantly increase the cost of implementing a base station. Thus cellular operators often place strict limits on the lengths, widths and/or depths of each type of base station antenna.

Multiband base station antennas that support cellular service in all three of the low-band, mid-band and high-band frequency ranges typically include at least eight columns of radiating elements, and often as many as twelve, sixteen or more columns of radiating elements. Because of the size constraints for the antenna, the back side of these antennas are often filled with RET units, phase shifters, coaxial cables, calibration boards and the like such that there is very little open space behind the reflector of the base station antenna. Each base station antenna is typically tested after the antenna is assembled to identify problems such as unintended passive intermodulation (“PIM”) distortion sources (such as poorly formed solder joints or loose metal-to-metal connections that can generate unwanted RF noise), faulty connections, inoperable components (e.g., phase shifters, RET units, etc.) and the like. When such problems are identified, it often is difficult to identify the source of the problem, let alone fix the problem, within the assembled antenna since it is difficult to access many of the components of the antenna (and in particular components that are behind the main reflector) due to the crowded design. As a result, when problems are identified, the base station antenna system often must be partly or completely disassembled to identify and fix the problems. This can greatly increase production costs.

Another problem with current multiband base station antennas is that the RF paths to radiating elements of at least some of the low-band, mid-band and high-band arrays may cross back and forth between the front and back sides of the main reflector. As a result, the RF performance of these arrays cannot be tested until the base station antenna is assembled. If problems are identified, the antenna then typically has to be disassembled to fix the problems.

Pursuant to embodiments of the present invention, base station antennas that support service in the low-band, mid-band and high-band frequency ranges are provided that are modular in nature. These base station antennas may include low-band, mid-band and high-band array assemblies that have modular designs for the RF feed cables, the phase shifter assemblies and the connections between the phase shifter assemblies and/or the radiating elements. This advantageously allows most of the components of the low-band, mid-band and high-band arrays to be tested before they are installed in the antenna, so that poor solder joints, improper connections and the like can be identified and corrected before the antenna is assembled. In addition, the base station antennas according to embodiments of the present invention may be designed so that the most or all of each modular low-band, mid-band and high-band array assembly may be removed from the assembled antenna without the need to remove other of the modular low-band, mid-band and high-band array assemblies. The capability to remove a single modular array assembly without removing other of the modular array assemblies can greatly simplify the process for addressing problems identified during testing of the assembled antenna. Moreover, in some cases, a portion of each radiating element (e.g., the feed stalks) in a modular array assembly can be pre-assembled on a phase shifter assembly of the modular array, and the remainder of each radiating element may be installed after the phase shifter assembly is mounted in the base station antenna.

At least some of the low-band, mid-band and high-band arrays in the base station antenna according to embodiments of the present invention may use so-called “wireless” cavity phase shifter assemblies. “Wireless” phase shifter assemblies refer to phase shifter assemblies that have outputs that connect directly to the radiating elements of the array (or feed board printed circuit boards for the radiating elements), thereby eliminating the need for coaxial “phase cables” that extend from the outputs of a conventional phase shifter assembly to the radiating elements of the array (or feedboard printed circuit boards for the radiating elements). A cavity phase shifter assembly refers to a phase shifter assembly in which the phase shifter is mounted within a grounded metal cavity so that the RF transmission lines of the phase shifter operate as stripline transmission lines. The use of stripline transmission lines may reduce insertion losses and shield the RF signals from RF noise. The use of wireless cavity phase shifter assemblies may significantly improve the modularity of a base station antenna as the radiating elements of the associated array may be mounted on the metal shell of the cavity phase shifter and/or because the need for phase cables may be reduced or eliminated. Moreover, the wireless cavity phase shifter assemblies may generally be mounted in the same plane within the back of the base station antenna so that any one wireless cavity phase shifter assembly can be removed without the need to remove other of the wireless cavity phase shifters.

The wireless cavity phase shifter assemblies that are included in the base station antennas according to embodiments of the present invention may be designed so that the RF feed cables that connect the RF ports of the antenna to the feed networks thereof are directly soldered to the metal shells of the wireless cavity phase shifter assemblies. This can be accomplished, for example, by selectively depositing a metal such as tin (or another solderable metal) onto a small portion of each metal shell so that a small section of the outer conductor of each RF feed cable can be soldered directly to the metal shell, and the inner conductor of each RF feed cable can be soldered directly to a main printed circuit board of the phase shifter that is mounted within a cavity in the metal shell. In other embodiments, metal pins that include a solderable metal coating may be are interference fit into holes in the metal shells, or metal blocks that include a solderable metal coating may be welded or soldered to the metal shells, and the RF feed cables may be soldered to the metal pins or metal blocks to galvanically connect the outer conductors of the RF feed cables to the metal shells. Providing galvanic connections between the RF feed cables and the wireless cavity phase shifter assemblies provides a continuous impedance that may result in improved RF performance, and may also eliminate any need to route the RF feed cables to the front side of the reflector (e.g., to a feed board printed circuit board) before the RF feed cables connect to the phase shifter assemblies.

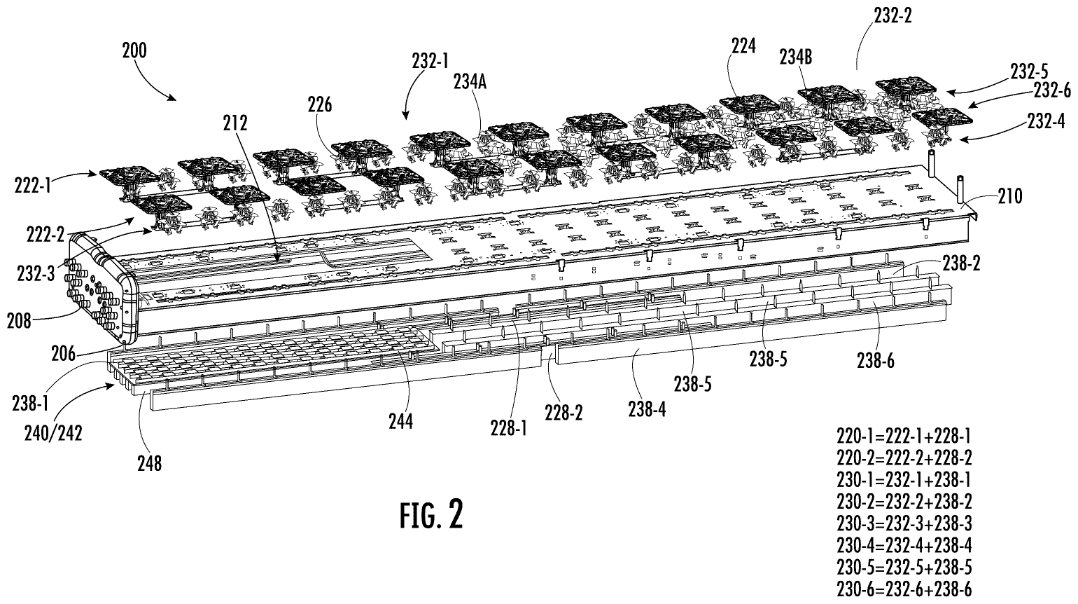

Embodiments of the present invention will now be described in greater detail with reference to FIGS. 2-12B.

FIG. 2 is a schematic exploded side perspective view of certain components of a base station antenna 200 according to embodiments of the present invention. As shown in FIG. 2, the base station antenna 200 includes a reflector 210, a plurality of RF ports 208 (that are mounted in a bottom end cap 206 of the antenna 200), first and second low-band linear array assemblies 220-1, 200-2, first through sixth mid-band linear array assemblies 230-1 through 230-6, and a multi-column high-band array assembly 240. It will be appreciated that a number of the components of base station antenna 200 are not shown in FIG. 2 such as, for example, a top end cap, a radome, the RF feed cables, RET actuators, mechanical linkages mechanical supports and the like. It will also be appreciated that the base station antenna can include numerous other components such as parasitic elements that shape the generated antenna beams, diplexers, etc.

As shown in FIG. 2, each low-band linear array assembly 220 includes a low-band cavity phase shifter assembly 228 and a low-band linear array 222 of low-band radiating elements 224. The low-band linear arrays 222 may generate static antenna beams that provide coverage to a predefined coverage area. Each low-band linear array 222 includes a total of eleven low-band radiating elements 224 that are arranged in a vertically-extending column. Each low-band radiating element 224 may be configured to operate in all or part of the 617-960 MHz frequency band. The low-band radiating elements 224 are mounted on feed board printed circuit boards 226 (which may be referred to simply as “feed boards” herein), with one or more low-band radiating element 224 mounted on each feed board 226. The low-band feed boards 226 arc mounted on the reflector 210 so that each of the low-band radiating elements 224 extends forwardly from the reflector 210. Each low-band cavity phase shifter assembly 228 is connected to a pair of the RF ports 208 (one RF port 208 for each of the two polarizations supported by the low-band radiating elements 224) by a respective RF feed cable (not shown). Each low-band cavity phase shifter assembly 228 includes a plurality of outputs that are electrically connected to the feed boards 226 by phase cables (not shown).

Still referring to FIG. 2, each mid-band linear array assembly 230 includes a mid-band cavity phase shifter assembly 238 and a linear array 232 of mid-band radiating elements 234A, 234B. In the depicted embodiment, the first through fourth mid-band linear arrays 232-1 through 232-4 include mid-band radiating elements 234A that are configured to operate in the 1695-2690 MHz frequency band, while the fifth and sixth mid-band linear arrays 232-5, 232-6 include mid-band radiating elements 234B that are configured to operate in the 1427-2690 MHz frequency band. Each of the first through fourth mid-band linear arrays 232-1 through 232-4 includes a total of eleven mid-band radiating elements 234A with the mid-band radiating elements 234A forming each array arranged in respective vertically-extending columns. The first and second mid-band linear arrays 232-1, 232-2 are stacked vertically on one side of the base station antenna 200 and the third and fourth mid-band linear arrays 232-3, 232-4 are stacked vertically on the other side of the base station antenna 200. Each of the fifth and sixth mid-band linear arrays 232-5, 232-6 includes a total of thirteen mid-band radiating elements 234B with the mid-band radiating elements 234B forming each array arranged in respective vertically-extending columns. The fifth and sixth mid-band linear arrays 232-1, 232-2 are positioned in the upper central region of reflector 210 and are primarily positioned between the second and fourth mid-band linear arrays 232-2, 232-4.

Each of the mid-band radiating elements 234A, 234B is mounted to extend forwardly from the reflector 210. The mid-band radiating elements 234A, 234B are not mounted on feed board printed circuit boards, as will be explained in greater detail below. Each mid-band cavity phase shifter assembly 238 is connected to a pair of the RF ports 208 (one RF port for each of the two polarizations supported by the mid-band radiating elements 234A, 234B) by respective RF feed cables (not shown). Each mid-band cavity phase shifter assembly 238 includes a plurality of outputs that may be directly connected to the feed stalks of the mid-band radiating elements 234A, 234B, as will be described in more detail below.

The lower portion of the reflector 210 includes a large opening 212. The multi-column high-band array assembly 240 is positioned within (or behind) this opening 212. The multi-column high-band array assembly 240 includes a high-band cavity phase shifter assembly 248 and a four column array 242 of high-band radiating elements 244. Each column of radiating elements in the four column array 242 includes a total of thirteen high-band radiating elements 244 that are arranged in a vertically-extending column. Each of the high-band radiating elements 244 may be mounted on a respective feed board (not visible in FIG. 2), and the feed boards may be mounted directly on the high-band cavity phase shifter assembly 248. The high-band cavity phase shifter assembly 248 serves as reflector and a ground plane for the high-band radiating elements 244. The high-band cavity phase shifter assembly 248 is connected to eight of the RF ports 208 (two RF ports for each column of high-band radiating elements 244) by respective RF feed cables (not shown).

It will be appreciated that the number and types of arrays included in base station antenna 200 are exemplary in nature and that different numbers and/or types or arrays may be provided in other embodiments. Likewise, it will be appreciated that the number radiating elements per array and the positions of the arrays may be varied from what is shown in FIG. 2 without departing from the scope of the present invention.

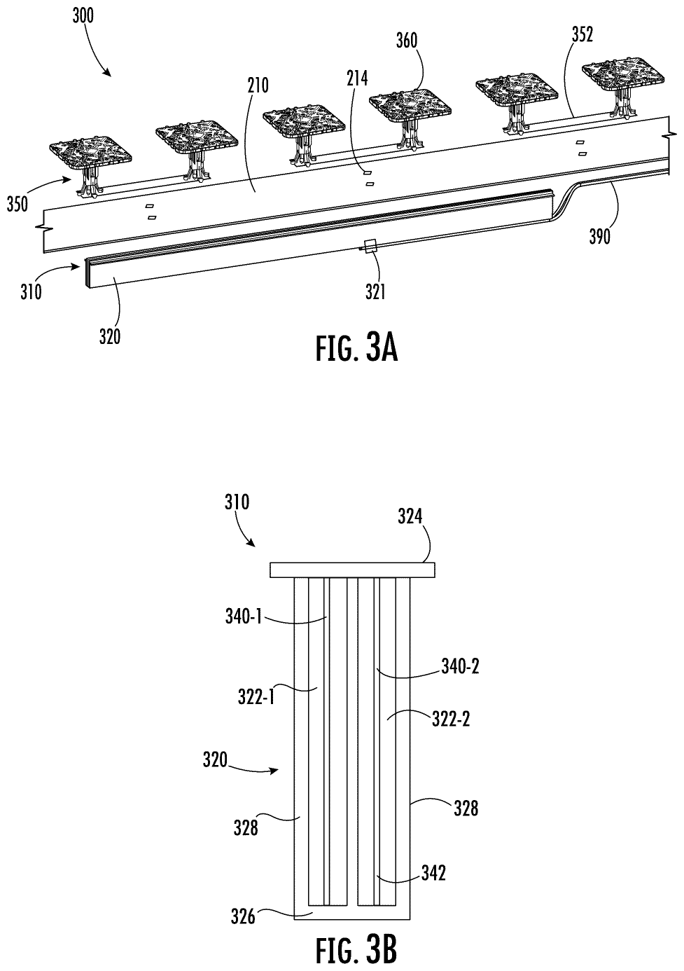

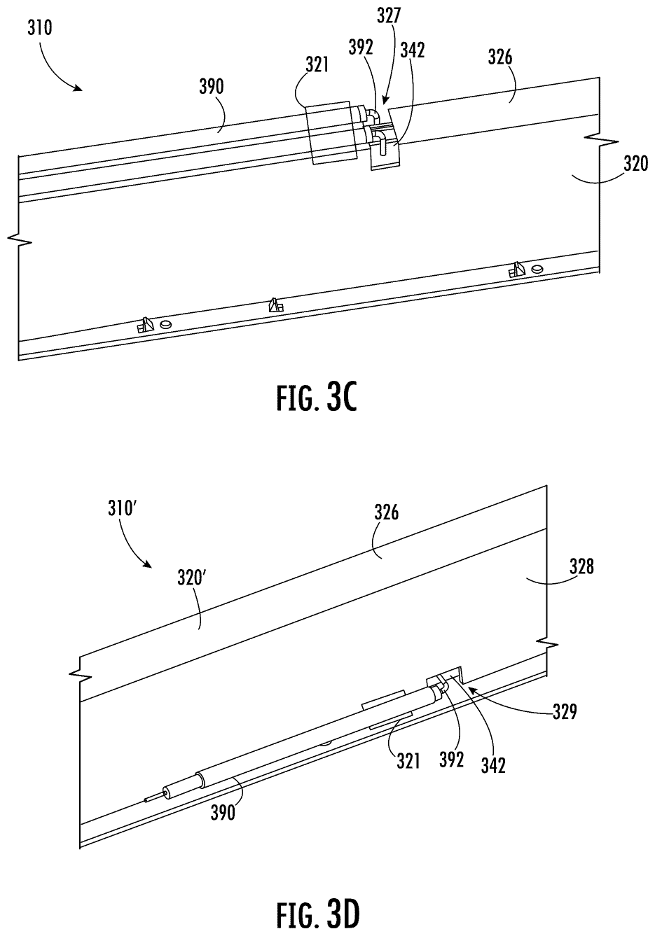

FIG. 3A is a schematic side perspective view of a representative portion of a low-band linear array assembly 300 that may be used to implement the low-band linear array assemblies 220-1, 220-2 included in the base station antenna of FIG. 2. As shown in FIG. 3A, the low-band linear array assembly 300 includes a cavity phase shifter assembly 310 (corresponding to cavity phase shifter assemblies 228-1, 228-2 of FIG. 2) and a low-band linear array 350 of low-band radiating elements 360 (corresponding to the low-band linear arrays 222-1, 222-2 of low-band radiating elements 224 of FIG. 2). The low-band radiating elements 360 are mounted on feed boards 352, with two low-band radiating elements 360 mounted on each feed board 352.

As shown in FIG. 3A, the cavity phase shifter assembly 310 is mounted rearwardly of the reflector 210 of base station antenna 200, while the low-band linear array 350 is mounted forwardly of the reflector 210. A plurality of openings 214 are provided in the reflector 210 to facilitate electrically connecting the cavity phase shifter assembly 310 to the linear array 350 of low-band radiating elements 360. First and second RF feed cables 390 of base station antenna 200 are physically and electrically connected to the cavity phase shifter assembly 310. A first end of each RF feed cable 390 is connected to a respective one of the low-band RF ports 208 of base station antenna 200, and the second end of each RF feed cable 390 is physically and electrically connected to the cavity phase shifter assembly 310.

Cavity phase shifter assemblies are known in the art. For example, U.S. Pat. No. 11,677,141 discloses a variety of cavity phase shifter assemblies and discusses the operation thereof. The entire content of U.S. Pat. No. 11,677,141 is incorporated herein by reference. Cavity phase shifter assemblies are typically used as they include low-loss stripline RF transmission lines and because they can be designed to provide cableless connections to the radiating elements, which reduces the number of solder joints. Any suitable cavity phase shifter assembly design may be used to implement the cavity phase shifter assemblies 310, including any of the cavity phase shifter assemblies disclosed in U.S. Pat. No. 11,677,141.

As shown in FIG. 3A, the cavity phase shifter assembly 310 includes a longitudinally-extending metal shell 320. FIG. 3B is a schematic end view of the cavity phase shifter assembly 310. As shown in FIG. 3B, first and second longitudinally-extending cavities 322-1, 322-2 are defined within the metal shell 320. The metal shell 320 includes a front wall 324, a rear wall 326 and a pair of sidewalls 328 that together define the cavities 322. As shown, the two cavities 322-1, 322-2 may share a common sidewall 328 in some cases.

As is further shown in FIG. 3B, a first phase shifter assembly 340-1 is mounted in the first cavity 322-1, and a second phase shifter assembly 340-2 is mounted in the second cavity 322-2. Each phase shifter assembly 340 may comprise, for example, a phase shifter printed circuit board 342 (see FIG. 3C) with RF transmission lines formed thereon. The phase shifter printed circuit board 342 may include an input port (not shown) such as a metal pad or trace that is electrically connected to an inner conductor 392 of a respective one of the RF feed cables 390, a power divider (not shown) that splits RF signals input through the input port into a plurality of sub-components, and a plurality of output ports (not shown) where the phase adjusted sub-components of the RF signal are output. Each phase shifter assembly 340 may also include a phase shifter (not shown), such as a sliding dielectric phase shifter, that is configured to impart an adjustable phase taper to the sub-components of the RF signal before they reach the respective output ports. Example phase shifter assemblies are described in detail in aforementioned U.S. Pat. No. 11,677,141.

In some embodiments, first and second portions of the exterior surface of the metal shell 320 may be selectively treated so that outer conductors of the respective RF feed cables 390 may be directly soldered to the metal shells 320 of the cavity phase shifter assembly 310. This can be accomplished, for example, by selectively depositing a metal such as tin (or other solderable metal) onto a small portion 321 of each metal shell 320 so that a small section of the outer conductor of each RF feed cable 390 can be soldered directly to the metal shell 320. The inner conductor 392 of each RF feed cable 390 can be soldered directly to metal pads on the phase shifter printed circuit boards 342 that serve as input ports thereto. Providing galvanic connections between both the inner and outer conductors of the RF feed cables 390 and the cavity phase shifter assemblies 310 provides a continuous impedance that may result in improved RF performance, and may also eliminate any need to route the RF feed cables 390 to the front side of the reflector 210 (e.g., to a feed board printed circuit board) before electrically connecting to the phase shifter assemblies 340.

While not clearly shown in the figures, the phase shifter printed circuit boards 342 may include forwardly extending tabs that include the output ports of the phase shifter assemblies 340. These output ports may extend through respective holes in the front walls 324 of the metal shell 320 (not shown) and through aligned openings 214 (see FIG. 3A) in the reflector 210 and into openings in the low-band feed boards 352. Solder joints may be applied to physically and electrically connect each output port to respective RF transmission lines on the low-band feed boards 352. Each low-band feed board 352 may include a pair of power dividers that split the RF signals provided thereto through the output ports of the phase shifter assemblies 340 and pass the sub-components of the split RF signals to the appropriate radiators of the low-band radiating elements 360. As shown in FIG. 2, in some cases the cavity phase shifter assembly 310 may not extend the full length of the low-band arrays 350. In such cases, phase cables may be connected between some of the output ports and the low-band feed boards 352 that do not overlap the cavity phase shifter assembly 310.

FIG. 3C is an enlarged schematic rear perspective view of a small portion of the cavity phase shifter assembly 310 of FIG. 3B. As shown in FIG. 3C, first and second RF feed cables 390 may be routed along the bottom edge of the metal shell 320. An opening 327 is formed in the bottom of the metal shell 320 that provides access to each of the cavities 322-1, 322-2. The inner conductors 392 of the RF feed cables 390 extend through the opening 327 and are soldered to the respective input ports (e.g., metal pads) on the phase shifter printed circuit boards 342 of the respective first and second phase shifter assemblies 340-1, 340-2. A solderable metal such as tin is selectively formed on a small portion 321 of each metal shell 320 adjacent the opening 327 so that a small section of the outer conductor of each RF feed cable 390 can be soldered directly to the metal shell 320 to provide galvanic connections between the outer conductors of the RF feed cables 390 and the metal shells 320.

The low-band linear array assembly 300 of FIGS. 3A-3C may have advantages over the low-band linear array assemblies of the conventional base station antenna 100 of FIGS. 1A-1B that use conventional microstrip phase shifters and phase cable connections to the low-band radiating elements 124. First, since the low-band linear array assembly 300 includes cavity phase shifter assemblies, the insertion loss may be reduced as compared to the low-band linear array assemblies of the conventional base station antenna 100 since the phase shifters are implemented using stripline as opposed to microstrip RF transmission lines. Additionally, while the cavity phase shifter assemblies 310 may not extend the full length of the low-band arrays 350 (see FIG. 2), they may extend a substantial percentage of this length, which acts to significantly reduce the number of phase cables. The cavity phase shifter assemblies 310 are also modular components that can be tested before being installed in base station antenna 200 and which can readily be removed from the base station antenna 200 without removing various other components, making it much easier to fix problems (e.g., poor solder joints) detected during antenna level testing.

FIG. 3D is an enlarged schematic rear perspective view of a portion of another cavity phase shifter assembly 310′ that can be used in place of the cavity phase shifter assembly 310 of FIG. 3C. As shown in FIG. 3D, the cavity phase shifter assembly 310′ is similar to the cavity phase shifter assembly 310, but instead of having an opening 327 in the rear wall 326 of the metal shell 320 that provides access to the cavities 322-1, 322-2 (as is the case in cavity phase shifter assembly 310), in cavity phase shifter assembly 310′ a pair of openings 329 are provided (only one is visible in FIG. 3D) near the front of the metal shell 320′ that provide access to the respective cavities 322-1, 322-2. As shown in FIG. 3D, the RF feed cables 390 may be routed adjacent the front edge of the metal shell 320′ behind a front lip. The openings 329 are formed in the sidewalls 328 of the metal shell 320′ to provide access to each of the cavities 322-1, 322-2. The inner conductors 392 of the RF feed cables 390 extend through the openings 329 and are soldered to the input ports (e.g., metal pads) on the phase shifter printed circuit boards 342. A solderable metal such as tin is selectively formed on a small portion 321 of each metal shell 320′ adjacent the opening 329 so that a small section of the outer conductor of each RF feed cable 390 can be soldered directly to the metal shell 320′. In this embodiment, the phase shifter printed circuit boards 342 may include respective openings and the inner conductors 392 of the respective RF feed cables 390 can be inserted into these respective openings.

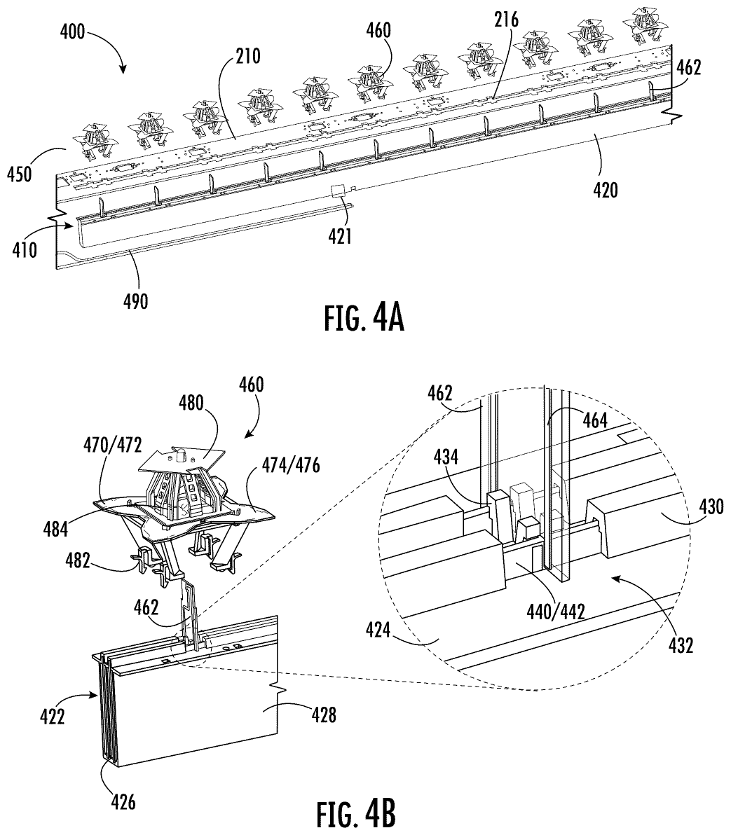

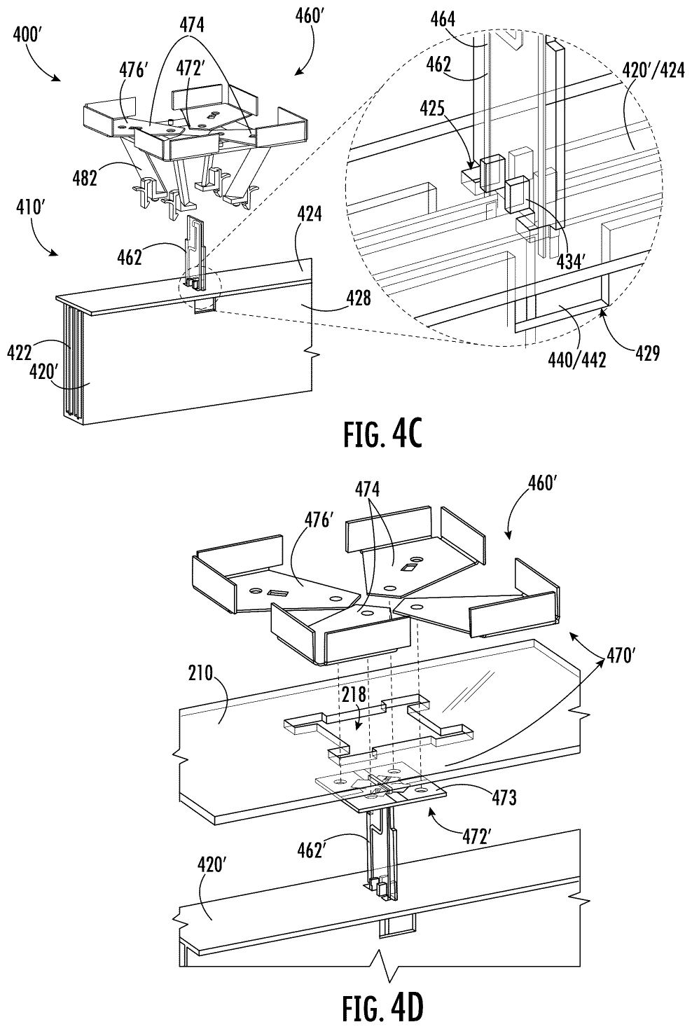

FIG. 4A is a schematic side perspective view of a mid-band linear array assembly 400 that may be used to implement the mid-band linear array assemblies 230 of the base station antenna 200 of FIG. 2.

As shown in FIG. 4A, the mid-band linear array assembly 400 includes a cavity phase shifter assembly 410 and a mid-band linear array 450 of mid-band radiating elements 460. The cavity phase shifter assembly 410 is mounted rearwardly of the reflector 210 of base station antenna 200, while the mid-band radiating elements 460 are partly mounted rearwardly of the reflector 210 of and partly mounted forwardly of the reflector 210. A plurality of openings 216 are provided in the reflector 210 and the feed stalks 462 of the mid-band radiating elements 460 extend through the openings 216, as will be explained in further detail below. A pair of RF feed cables 490 of base station antenna 200 are electrically connected to the cavity phase shifter assembly 410. The RF feed cables 490 may be connected to the cavity phase shifter assembly 410 in the same manner that the RF feed cables 390 are electrically connected to the cavity phase shifter assemblies 310 (i.e., be selectively depositing a solderable metal onto a portion 421 of a metal shell 420 of wireless cavity phase shifter assembly 410) and hence further description of these connections will be omitted.

As shown in FIG. 4A, the cavity phase shifter assembly 410 includes a longitudinally-extending metal shell 420 having first and second cavities 422-1, 422-2 provided therein. First and second phase shifter assemblies 440-1, 440-2 that include respective phase shifter printed circuit boards 442 are mounted in the respective first and second cavities 422-1, 422-2. The metal shell 420, cavities 422 and phase shifter assemblies 440 may be similar to metal shell 320, cavities 322 and phase shifter assemblies 340 of the low-band cavity phase shifter assembly 310 and hence further description thereof will be omitted.

FIG. 4B is an enlarged schematic perspective view of a small portion of the mid-band linear array assembly 400 of FIG. 4A with a callout that illustrates how the feed stalks 462 of the mid-band radiating elements 460 are mounted on the metal shell 420 of the mid-band linear array assembly 400.

As shown in FIG. 4B, the front wall 424 of the metal shell 420 of the cavity phase shifter assembly 410 includes a pair of longitudinally-extending protrusions 430 that have internal channels that are open to the respective cavities 422 formed in the metal shell 420. The phase shifter printed circuit boards 442 extend into the channels in the respective protrusions 430. The metal shell 420 may be formed, for example, by extrusion. A small portion of each of the protrusions 430 may be removed in positions located rearwardly of the mid-band radiating elements 460 to form gaps 432. The gaps 432 expose top portions of the phase shifter printed circuit boards 442. Output ports of the mid-band phase shifter assemblies 430 may be positioned at these locations.

As is further shown in FIG. 4B, each mid-band radiating element 460 may include a feed stalk 462 that is implemented using a printed circuit board, a dipole radiator assembly 470 that is implemented as a dipole radiator printed circuit board 472 that includes the dual-polarized dipole radiators 474 of the mid-band radiating element 470, a director 480 and first and second sets of plastic supports 482, 484. Each dipole radiator 474 may comprise a pair of center fed dipole arms 476, as is well understood in the art. The first set of plastic supports 482 is used to mount the dipole radiator printed circuit board 472 on and forwardly of the metal shell 420 and the second set of plastic supports 484 is used to mount the director 480 forwardly of the dipole radiator printed circuit board 472. As shown in the callout of FIG. 4B, the feed stalk 462 includes a pair of slots that receive the first and second phase shifter printed circuit boards 442 of the mid-band phase shifter assembly 440. The signal trace of each output port on the phase shifter printed circuit boards 442 may be electrically connected (e.g., through a solder joint) to a respective signal trace 464 on the feed stalk 462. The ground connection of each output port on the phase shifter printed circuit boards 442 may be electrically connected (e.g., through a solder joint) to a portion of the metal shell 420 (e.g., to ground pins 434 formed by partially removing the protrusions 430). A solderable metal is formed on selected portions 421 of the metal shell 420 (see FIG. 4A) and on the ground pins 434 to facilitate forming the ground connections using solder joints.

The feed stalks 462 of the mid-band radiating elements 460 may be mounted on the metal shell 420 before the mid-band phase shifter assembly 410 is installed in the base station antenna 200. Thus, the performance of the feed stalks 462 may be tested before the base station antenna 200 is assembled. In some cases, the dipole radiator printed circuit boards 472 may also be temporarily mounted on the feed stalks 462 (but not soldered in place) using a fixture during this pre-assembly testing.

The mid-band linear array assembly 400 of FIGS. 4A-4B may have advantages over the mid-band linear array assembly of the conventional base station antenna 100 of FIGS. 1A-1B. First, since the cavity phase shifter assemblies 410 are modular components, they can be tested before they are installed in the base station antenna 200 and, if problems are identified later during antenna level testing, the mid-band linear array assemblies 400 can readily be removed from the base station antenna 200 without removing various other components, making it much easier to fix problems (e.g., poor solder joints) detected during antenna level testing. In addition, the need for mid-band feed boards is eliminated, as is the need for the RF input cable to attach to such feed boards. Moreover, since galvanic ground connections are provided, a continuous impedance is maintained which may improve RF performance.

FIG. 4C is an enlarged schematic perspective view of a portion of an alternative mid-band linear array assembly 400′ that can be used in the base station antenna of FIG. 2 instead of the mid-band linear array assembly 400 of FIGS. 4A-4B. The callout in FIG. 4C illustrates how the feed stalks 462 of the mid-band radiating elements 460′ that are included in mid-band linear array assembly 400′ are mounted on a cavity phase shifter assembly 410′ of the alternative mid-band linear array assembly 400′. As shown in FIG. 4C, the alternative mid-band linear array assembly 400′ includes a different cavity phase shifter assembly 410′ and radiating elements 460′ that have a modified design.

The cavity phase shifter assembly 410′ includes a metal shell 420′ that does not include the protrusions 430 but instead is initially formed to have a generally flat front wall 424 that includes a pair of longitudinally-extending ribs (not shown) that extend forwardly from the front wall 424. These ribs may then be almost completely removed using, for example, computer-based machining to leave a pair of ground pins 434′. Openings 425 are also formed in the front wall 424 adjacent the ground pins 434′. The feed stalks 462 include rearwardly-extending tabs that are inserted into the respective openings 425. The bottom portion of each rearwardly-extending tab of the feed stalks 462 has a slot formed therein that receives the respective phase shifter printed circuit boards 442 of the phase shifter assemblies 440. The output ports on the phase shifter printed circuit boards 442 are electrically connected to respective RF transmission lines 464 on the feed stalks 462 by forming solder joints through windows 429 that are provided in the outer sidewalls 428 of each metal shell 420′. A solderable metal is selectively deposited on the ground pins 434′ and the ground pins 434′ are then soldered to ground pads on the feed stalks 462′ to provide a fully galvanic connection between the cavity phase shifter assemblies 410 and the radiating elements 460′.

FIG. 4D is an enlarged schematic exploded perspective view of the mid-band radiating element 460′ illustrated in FIG. 4C that shows how the radiating element 460′ can be assembled through the reflector 210 of the base station antenna 200 of FIG. 2. As shown in FIG. 4D, the radiating element 460′ includes the feed stalk 462, a dipole radiator assembly 470′ that includes a small printed circuit board 472′ and a plurality of sheet metal dipole arms 476′. The small printed circuit board 472′ is mounted on the forward end of the feed stalk 462. The small printed circuit board 472′ includes four metal pads 473 that are fed by the feed stalk 462. The four sheet metal dipole arms 476′ are mounted on the small printed circuit board 472′ with a solder mask or other insulating layer interposed therebetween so that each sheet metal dipole arm 476′ is capacitively coupled to a respective one of the metal pads 473. Each sheet metal dipole arm 476′ has outer portions that are bent in the forward direction to reduce the footprint of each dipole arm 476′ while maintaining a desired electrical length for the dipole arm 476′. The first and second sheet metal dipole arms 476′ form a first dipole radiator 474 and the third and fourth sheet metal dipole arms 476′ form a second dipole radiator 474. The reflector 210 includes larger openings 218 that are larger than the footprint of the small printed circuit board 472′ so that the feed stalks 462 may be mounted on the metal shell 420′ and the small printed circuit board 472′ may be mounted on the respective feed stalks 462 before the mid-band phase shifter assembly 410′ is installed in the base station antenna 200. This allows testing of the mid-band phase shifter assembly 410′ before installation so that any problems may be addressed before the base station antenna 200 is assembled. Once the mid-band phase shifter assembly 410′ passes testing, it is installed in the antenna 200 behind the reflector 200 and the feed stalks 462 with the small printed circuit boards 472′ mounted thereon are passed through the respective openings 218 in the reflector 210. The dipole arms 476′ and plastic supports 482, are then mounted on the small printed circuit boards 472′ to complete fabrication of the mid-band radiating elements 460′.

Referring again to FIGS. 2 and 4A-4D, pursuant to embodiments of the present invention, base station antennas such as base station antenna 200 are provided that comprise a reflector 210, a phase shifter assembly 440 that includes a phase shifter printed circuit board 442, and a radiating element 460; 460′ that includes at least one feed stalk 462 and a radiator 474 that is mounted on the feed stalk 462 forwardly of the reflector 210. The feed stalk 462 is mounted directly on the phase shifter printed circuit board 442.

The phase shifter printed circuit board 442 may be mounted rearwardly of the reflector 210. The reflector 210 includes an opening 216; 218 and the feed stalk 462 extends through the opening 216; 218. The radiating element 460; 460′ may be a dual-polarized radiating element, the radiator 474 may be a first radiator 474-1 and the radiating element 470; 470′ includes a second radiator 474-2, and the feed stalk 462 is implemented using a single printed circuit board that includes a pair RF transmission lines 464 that feed the respective radiators 474-1, 474-2.

As shown in FIGS. 4C and 4D, in some embodiments, the radiator 474 may comprise a small printed circuit board 472′ that includes a pair of metal pads 473 and a pair of sheet metal dipole arms 476′ that are configured to capacitively couple with the respective first and second metal pads 473. The opening 218 in the reflector 210 is larger than the printed circuit board 472′ so that the printed circuit board 472′ can be passed through the opening 218.

Referring again to FIGS. 2 and 4A-4D, the phase shifter assembly 440 is part of a cavity phase shifter assembly 410; 410′ that further includes a metal shell 420; 420′, and the phase shifter printed circuit board 442 is mounted within the metal shell 420; 420′. The feed stalk 462 includes a slot and the phase shifter printed circuit board 442 extends into the slot. The feed stalk 462 is mounted on the phase shifter printed circuit board 442 adjacent an output on the phase shifter printed circuit board 442, and a solder joint electrically connects the output to a signal trace on the feed stalk 462. A ground pin 434; 434′ extends forwardly from the metal shell 420; 420′, and the ground pin 434; 434′ is soldered to a ground conductor on the feed stalk 462. A solderable metal coating may be selectively formed on the ground pin 434; 434′.

In some embodiments, the metal shell 420 includes a forwardly extending protrusion 430 that defines an internal channel, and the phase shifter printed circuit board 442 is received within the internal channel. The forwardly extending protrusion 430 includes a gap 432 that exposes the phase shifter printed circuit board 442, and the feed stalk 462 is mounted on the phase shifter printed circuit board 442 within the gap 432. A ground pin 434 extends forwardly from the metal shell 420 within the gap 432, and a profile of the ground pin 434 may match a profile of at least a portion of the forwardly extending protrusion 430.

Referring to FIGS. 4C-4D, in some embodiments, a front wall 424′ of the metal shell 420′ may include an opening 425, and the feed stalk 462 may extend through the opening 425. A sidewall 428 of the metal shell 420′ includes a window 429 that is aligned with the opening 425 in the front wall 424′ of the metal shell 420′. The feed stalk 462 extends into a cavity 422 within the metal shell 420′ and is mounted on the phase shifter printed circuit board 442 within the cavity 422.

Referring to FIGS. 4C-4D, pursuant to further embodiments of the present invention, base station antennas such as base station antenna 200 are provided that include a reflector 210 having an opening 218 therein. A radiating element 460′ that includes a feed stalk 462 and a printed circuit board 472′ mounted adjacent a forward end of the feed stalk 462. The printed circuit board 472′ extends perpendicular to the feed stalk 462. A footprint of the opening 218 in the reflector 210 is larger than a footprint of the printed circuit board 472′ and the opening 218 is aligned with the printed circuit board 472′.

The printed circuit board 472′ may include first through fourth metal pads 473, and the radiating element 460′ may further comprise first through fourth sheet metal dipole arms 476′ that are mounted on the printed circuit board 472′ and configured to capacitively couple with the respective first through fourth metal pads 473. The combined footprint of the four sheet metal dipole arms 476′ may be larger than the footprint of the opening 218. The base station antenna 200 may further include a cavity phase shifter assembly 410′ that is mounted rearwardly of the reflector 210, the cavity phase shifter assembly 410′ including a metal shell 420′ and a phase shifter printed circuit board 442 that is mounted within a cavity 422 in the metal shell 420′. A ground conductor on the feed stalk 462 may be galvanically connected to the metal shell 420′. The feed stalk 462 may extend into the cavity 422 within the metal shell 420 and may electrically connect to the phase shifter printed circuit board 442 within the cavity 422. The metal shell 420′ may include a forwardly extending ground pin 434′ that is soldered to the feed stalk 462.

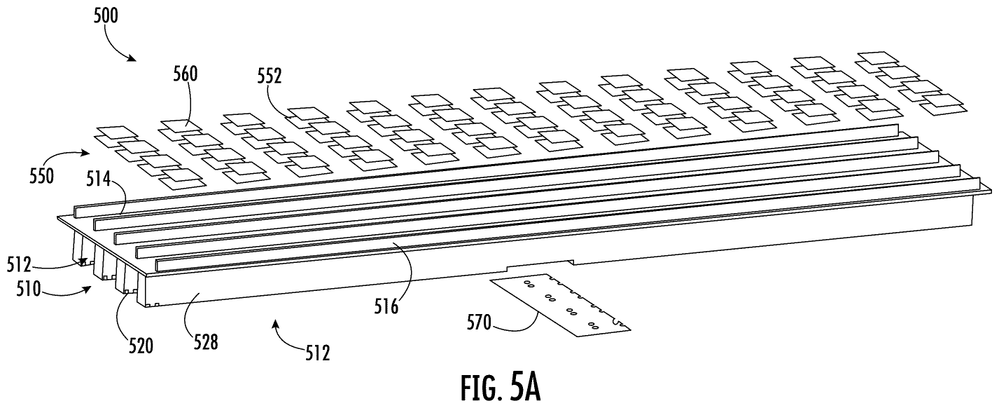

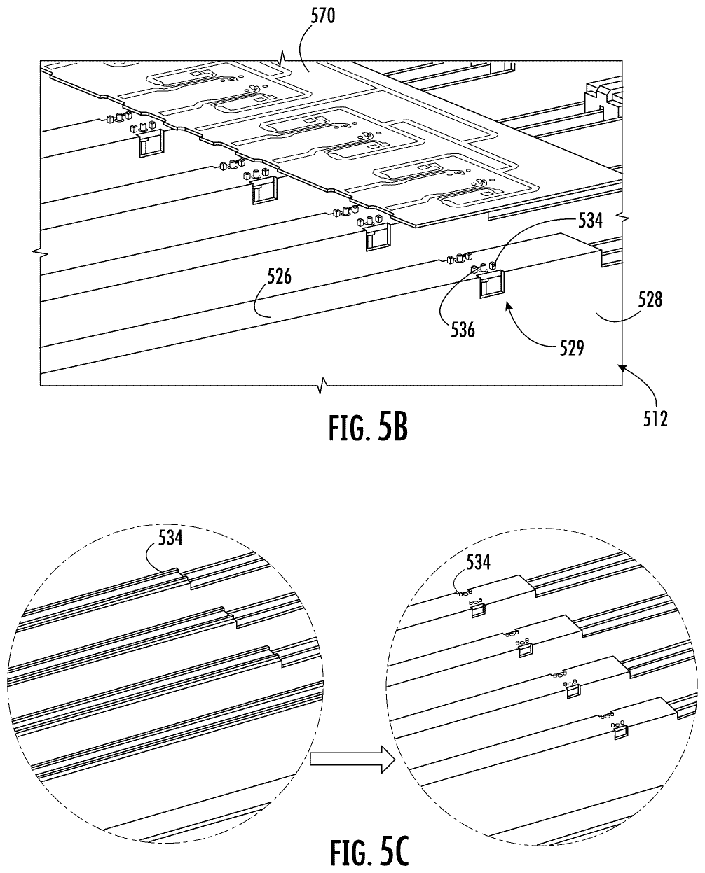

FIG. 5A is a schematic side perspective view of a high-band multi-column array assembly 500 that may be used to implement the high-band multi-column array assembly 240 included in the base station antenna 200 of FIG. 2. As shown in FIG. 5A, the high-band multi-column array assembly 500 includes a cavity phase shifter assembly 510 and a four-column array 550 of high-band radiating elements 560. The cavity phase shifter assembly 510 includes a composite metal shell 512 that has a front wall 514 that acts as a reflector and ground plane for the high-band radiating elements 560 of the four-column array 550. A plurality of metal isolation walls 516 extend forwardly from the front wall 514 of the composite metal shell 512. The isolation walls 516 improve the isolation between adjacent columns of high-band radiating elements 560. The composite metal shell 512 includes four metal shells 520. Each metal shell 520 includes a pair of cavities 522, and a high-band phase shifter assembly 540 that includes a phase shifter printed circuit board 542 is mounted in each cavity 522. Each metal shell 520 may have the same design as the metal shells 320, 420 described above and therefore further description thereof will be omitted here. The four metal shells 520 may be formed at the same time using an extrusion process so that the four metal shells 520 are integral with each other (monolithic) to form the composite metal shell 512. The phase shifter assemblies 540 may be mounted in the cavities 522 in the same manner described above with respect to the low-band and mid-band linear array assemblies 300, 400.

Each high-band radiating element 560 is mounted on a respective high-band feed board 552. The high-band feed boards 552 may be mounted directly on the front wall 514 of the composite metal shell 512. Openings (not shown) are provided in the front wall 514 so that tabs on the phase shifter printed circuit boards 542 of the high-band phase shifter assemblies 540 extend outside the cavities 522 to physically and electrically connect to the high-band radiating elements 560.

As further shown in FIG. 5A, a calibration printed circuit board 570 may be mounted on the rear of the composite metal shell 512. Directional couplers (not shown) are provided on the printed circuit boards 542 of each phase shifter assembly 540. These directional couplers are configured to tap small portion of the RF signals that are fed to each phase shifter assembly 540 and to pass these tapped RF signals to the calibration printed circuit board 570. The calibration printed circuit board 570 includes a plurality of combiners that are used to combine the tapped RF signals, and a calibration port on the calibration printed circuit board 570 is connected back to the beamforming radio by, for example, a coaxial cable. As is known in the art, the calibration signals passed from the calibration board 570 to the beamforming radio are used by the beamforming radio to adjust the amplitudes and phases of the sub-components of the RF signal passed to each column of the multi-column beamforming array 550 to compensate for unintended changes in the amplitudes and phases of the RF signals that occur due to manufacturing tolerances, temperature changes and the like.

FIG. 5B is an exploded schematic rear perspective view illustrating the connection between the calibration board 570 and the composite metal shell 512 of the high-band multi-column array assembly 500 of FIG. 5A. As shown in FIG. 5B, ground pins 534 arc formed on each of the metal shells 520. The ground pins 534 may be formed by forming rearwardly extending walls on the rear wall of each metal shell 520 and then machining away most of each wall to form the ground pins 534, as schematically shown in FIG. 5C. The portion of each metal shell 520 that includes the ground pins 534 may be selectively treated to include a solderable metal coating (e.g., a tin coating may be formed on a selected region of the metal shell 520). Each ground pin 534 may be inserted into a corresponding hole in the calibration printed circuit board 570 to mechanically mount the calibration printed circuit board 570 on the composite metal shell 512. The ground pins 534 may be galvanically connected to a ground plane of the calibration printed circuit board 570 in order to provide a galvanic ground plane connection between the composite metal shell 512 and the calibration printed circuit board 570. Windows 529 are formed in the sidewalls 528 of the metal shells 520 so that conductive pins 536 may be soldered to the signal traces on phase shifter printed circuit boards 542. The conductive pins 536 may be received within holes in the calibration printed circuit board 570 where they may be soldered to respective signal traces on the calibration printed circuit board 570.

The high-band multi-column array assembly 500 may be tested before it is assembled into the base station antenna 200. It also can be removed from base station antenna 200 without removing any of the low-band or mid-band linear array assemblies 300, 400, making rework far easier. In addition, the calibration printed circuit board 570 is connected to the cavity phase shifter assembly 510 by the ground pins 534 and the conductive pins 536, eliminating the need for cabled connections and reducing the insertion loss. The cavity phase shifter assembly 510 also provides cableless connections directly to the high-band patch radiating elements 560, which facilitates high antenna gain. The modular design may also have high consistency and good manufacturability.

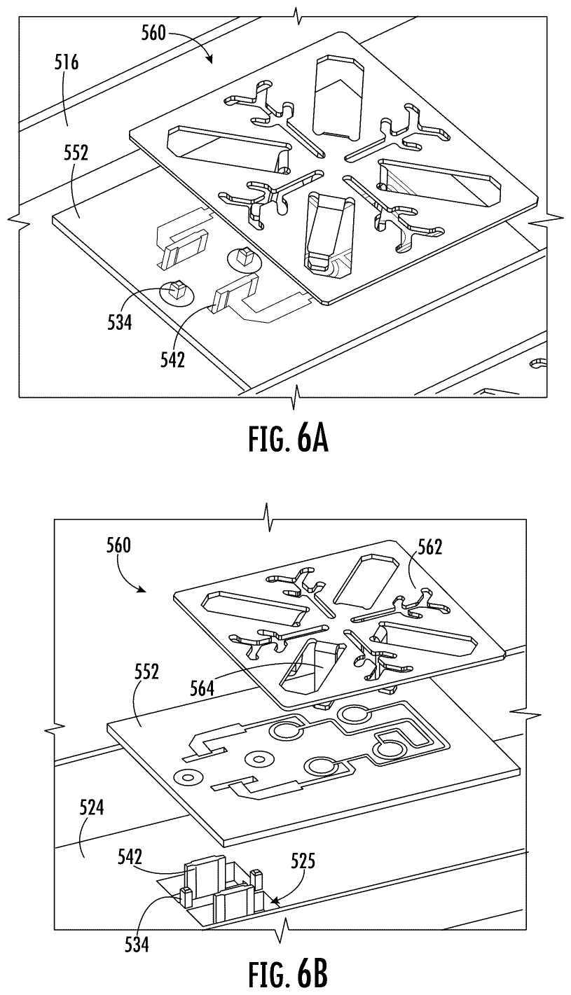

FIGS. 6A and 6B are enlarged schematic front assembled and exploded perspective views illustrating how one of the high-band radiating elements 560 can be mounted on the metal shell 520 of the high-band multi-column array assembly 500 with a galvanic ground connection.

Referring to FIGS. 6A-6B, it can be seen that each high-band radiating element 560 may be implemented as a dual-polarized patch radiating element that includes a feed board 552 and a patch radiator 562 that is mounted forwardly of the feed board 552 via a plurality of rearwardly extending legs 546 on the patch radiator 562. As can be seen in FIG. 6B, a pair of openings 525 are formed in the front wall 524 of the metal shell 520 rearwardly of the locations where each high-band radiating element 560 is to be mounted. In addition, a pair of forwardly-extending ground pins 534 are provided on the front wall 524. These ground pins 534 may be formed in the same fashion as the ground pins 534 described above that are formed on the rear walls of the metal shells 520. Each phase shifter printed circuit board 542 includes a forwardly extending tab that includes an output port. These forwardly extending tabs extend through the openings 525 in the front wall 524 of the metal shell 520 and through mating slots in the feed board 552. Solder joints (not shown) are provided that electrically connect the output ports on the tabs to corresponding RF transmission lines on the feed board 552 to provide a galvanic connection between the signal traces on the phase shifter printed circuit boards 542 and the RF transmission lines on the feed boards 552. Additionally, a solderable metal (e.g., a tin plating) is applied to the ground pins 534 so that the ground pins 534 may be inserted through mating openings in the feed board 552 and soldered in place to provide a galvanic ground connection between the phase shifter assemblies 530 and the RF transmission lines on the feed boards 552. This direct grounding provides a more continuous impedance which reduces the risk of a cavity resonance and improves RF performance.

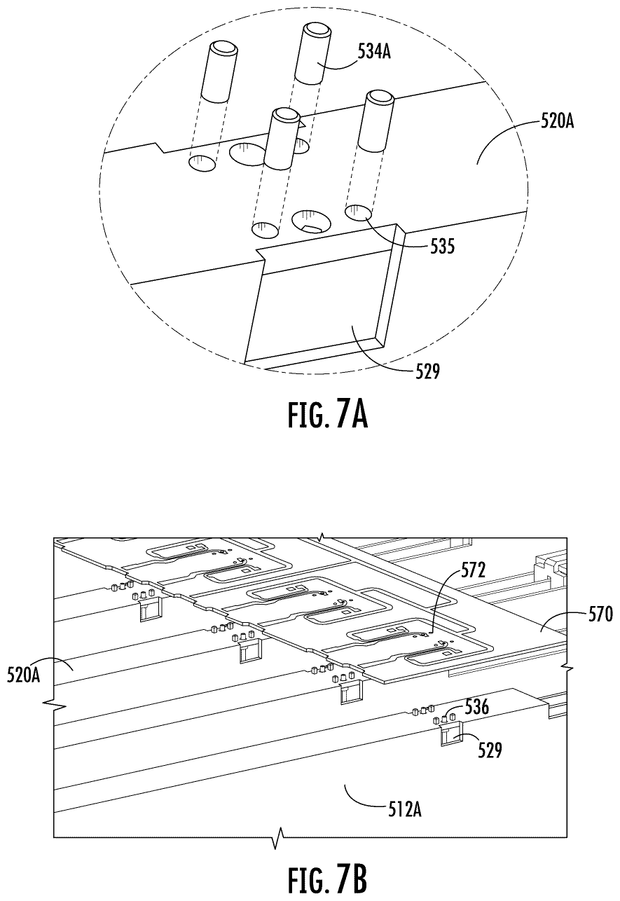

FIGS. 7A and 7B are exploded schematic rear perspective views that illustrate a technique according to further embodiments of the present invention for connecting the calibration printed circuit board 570 to a composite metal shell 512A that is a slightly modified version of the composite metal shell 512 shown in FIG. 5A. As discussed above, the ground pins 534 of FIGS. 5B-5C are formed by machining away most of a plurality of rearwardly-extending walls that are formed on the rear wall of each metal shell 520 of composite metal shell 512. In contrast, as shown in FIG. 7A, in composite metal shell 512A, holes 535 are formed on the rear wall of each metal shell 520A. A metal rod (not shown) that is coated with a solderable material (e.g., a tin-coated metal rod) is cut into pieces to provide a plurality of metal ground pins 534A. The metal ground pins 534A are inserted into the holes 535 and held in place by an interference fit. This avoids the machining operation that is used to form the metal ground pins 534 of composite metal shell 512 that is discussed above with reference to FIGS. 5B and 5C. Each metal ground pin 534A may be inserted into a corresponding plated through hole 572 in the calibration printed circuit board 570 to mechanically mount the calibration printed circuit board 570 on the composite metal shell 512A. The provision of the metal ground pins 534A that include a solderable metal coating (e.g., a tin coating) avoids any need to selectively coat the metal shells 520A with a solderable metal. Solder joints may be applied on the exposed rear surface of the calibration printed circuit board 570 to provide good mechanical and electrical connections between the ground pins 534A and the calibration printed circuit board 570. The ground pins 534A may be galvanically connected to a ground plane that is provided on the forward surface of the calibration printed circuit board 570. Composite metal shell 512A includes the above-discussed windows 529 in the sidewalls of the metal shells 520A so that conductive pins 536 may be soldered to the signal traces on the phase shifter printed circuit boards 542. The conductive pins 536 may be received within holes in the calibration printed circuit board 570 where they may be soldered to respective signal traces on the calibration printed circuit board 570.

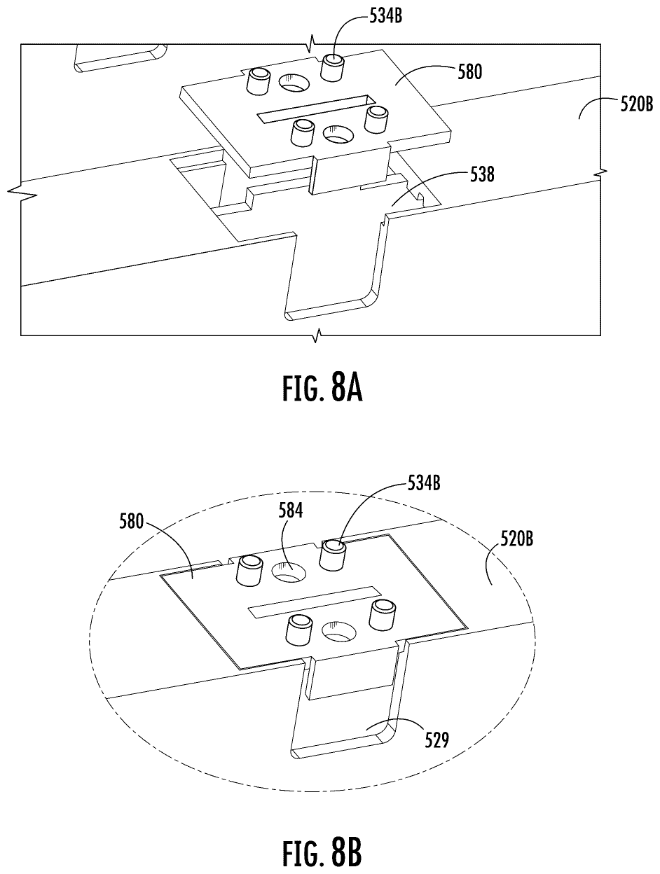

FIGS. 8A and 8B are an exploded rear perspective view and a rear perspective view, respectively, that illustrate a connection according to additional embodiments of the present invention between the calibration printed circuit board 570 and a composite metal shell 512B that is another modified version of the composite metal shell 512 shown in FIG. 5A. As can be seen by comparing FIGS. 5A-5C and 8A-8B, a rear surface of the portion of each metal shell 520B where the ground pins 534 of composite metal shell 512 (FIGS. 5B-5C) were provided is cut away to leave an opening 538 in the rear surface of each metal shell 520B. A metal ground block 580 (e.g., an aluminum block) that is coated with a solderable material (e.g., a tin-coated metal block) is provided. The metal ground block 580 may comprise, for example, a die cast metal ground block or may be formed by machining. The metal ground blocks 580 are sized to cover the openings 538 in the rear surface of each metal shell 520B while not covering or only partially covering the windows 529 in the sidewalls of the metal shells 520B, as shown in FIG. 8B. A welding or laser soldering process (or other suitable process) may be used to affix each metal ground block 580 into place to cover the openings 538 in the respective metal shells 520B.

Each metal ground block 580 includes a plurality of rearwardly-extending ground pins 534B. The provision of the metal block 580 that include a solderable metal coating (e.g., a tin coating) avoids any need to selectively coat the metal shells 520B with a solderable metal. The ground pins 534B are inserted into the corresponding plated through holes 572 (see FIG. 7B) in the calibration printed circuit board 570 to mechanically mount the calibration printed circuit board 570 on the metal shells 520B. Solder joints may be applied on the exposed rear surface of the calibration printed circuit board 570 to provide good mechanical and electrical connections between the metal ground pins 534B and the calibration printed circuit board 570. The ground pins 534B may be galvanically connected to a ground plane on the calibration printed circuit board 570. The metal ground block 580 also includes a pair of holes 584. Each metal shell 520B includes the above-discussed windows 529 in the sidewalls thereof so that conductive pins 536 (which typically each include an annular outer dielectric covering that insulates the conductive pins 536 from the metal shells 520B) may be inserted through these holes 584 into the cavities within the respective metal shells 520B so that a first end of each conductive pin 536 can be soldered to the signal traces on the phase shifter printed circuit boards 542 that are mounted within the respective metal shells 520B. The second end of each conductive pin 536 may be received within a respective hole in the calibration printed circuit board 570 where they are soldered to respective signal traces on the calibration printed circuit board 570. In this fashion, each signal trace on the calibration printed circuit board 570 may be electrically connected to a corresponding signal trace on a respective one of the phase shifter printed circuit boards 542.

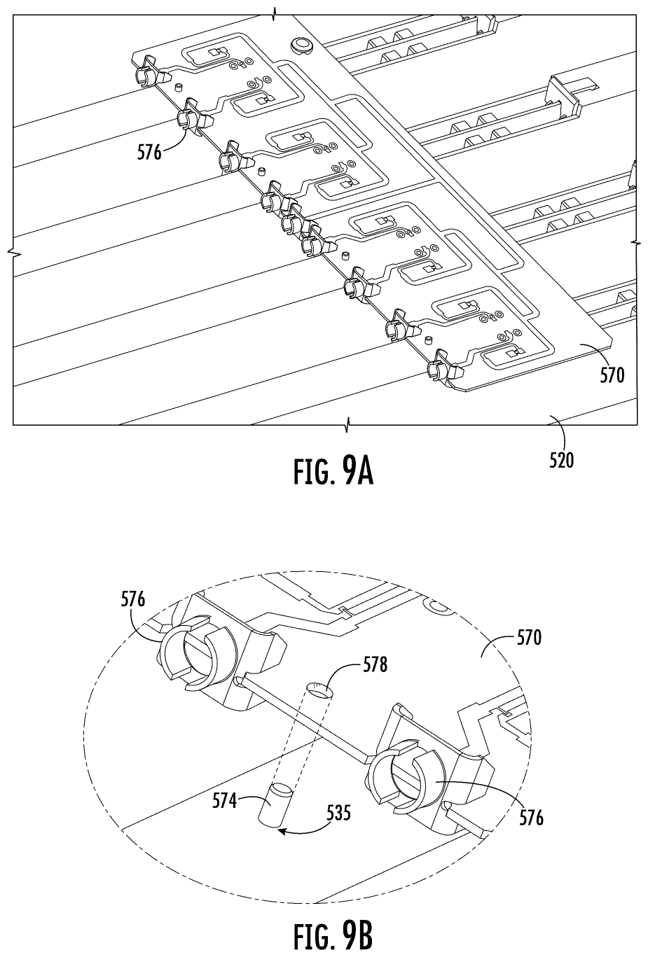

FIGS. 9A and 9B are a rear perspective view and an exploded rear perspective view, respectively, that illustrate how isolation pins 574 may be mounted in the calibration printed circuit board 570 and/or the composite metal shell 512 of the high-band multi-column array assembly 500 of FIG. 5A in order to improve isolation between selected of the input ports on the calibration printed circuit board 570. As shown in FIGS. 9A-9B, fixtures 576 may be mounted on an edge of the calibration printed circuit board 570. Each fixture 576 may be configured to receive a coaxial cable (not shown). The coaxial cables may be RF input cables that are connected (either directly or indirectly) to the respective ports of a beamforming radio (not shown). The fixtures 576 may be configured to electrically connect the outer conductor of each coaxial cable to a ground plane on the forward side of the calibration printed circuit board 570 and to connect the inner conductor of each coaxial cable to a respective signal trace on the calibration printed circuit board 570.

Metal isolation pins 574 are provided. A metal (e.g., aluminum) rod that is coated with a solderable material (e.g., a tin-coated aluminum rod) is cut into pieces to provide the isolation pins 574. The isolation pins 574 are inserted into holes 535 in the metal shells 520 and held in place by an interference fit. Corresponding holes 578 are formed in the calibration printed circuit board 570 so that the isolation pins 574 may be mounted in the holes 535 in the metal shells 520 and extend through the holes 578 in the calibration printed circuit board 570 so that the isolation pins 574 extend rearwardly from the calibration printed circuit board 570. Respective metal pads (not shown) may surround the holes 578 so that the isolation pins 574 may be soldered to the calibration printed circuit board 570 and galvanically connected to a ground plane on the calibration printed circuit board 570. The isolation pins 574 may be positioned between respective pairs of the fixtures 576 and may reduce unwanted coupling between the fixtures 576.

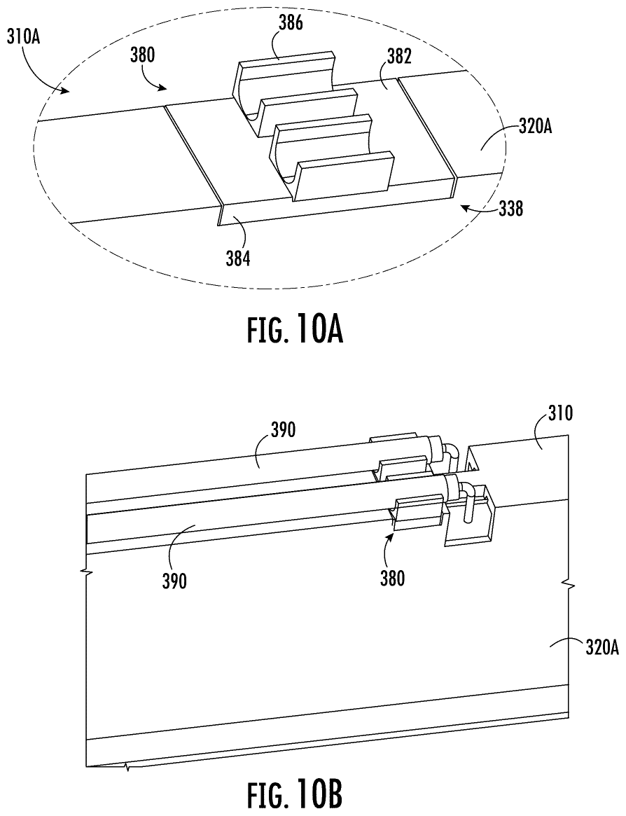

FIG. 10A is an enlarged schematic rear perspective view of a small portion of a cavity phase shifter assembly 310A that may be used in place of one of the cavity phase shifters 310 of FIGS. 3A-3C. The cavity phase shifter assembly 310A includes an opening 338, and a cable block 380 is mounted to cover the opening 338. The cable block 380 may be welded or laser soldered to the cavity phase shifter assembly 310A. The cable block 380 may comprise a flat plate 382 with short forwardly-extending sidewalls 384. A pair of cable holders 386 extend rearwardly from the plate 382 and are each configured to receive a portion of a respective coaxial cable that has had its outer insulating jacket removed. The cable holder 380 may be, for example, die cast or formed by machining. The cable holder 380 may comprise a suitable metal, such as aluminum, and may be coated with a solderable material (e.g., a tin-coated).

FIG. 10B is a schematic rear perspective view of a portion of the cavity phase shifter assembly 310A shown in FIG. 10A with a pair of RF feed cables 390 mounted in the cable block 380 and soldered in place. The cable jacket of each RF feed cable 390 may be removed from the portion of the RF feed cable 390 that is received within the respective cable holders 386 of the cable block 380 so that the outer conductors are galvanically connected to the metal shell 320A of the cavity phase shifter assembly 310A by soldered connections. Similar to cavity phase shifter assembly 310 discussed above with reference to FIGS. 3A-3C, the inner conductor 392 of each RF feed cable 390 is soldered directly to metal pads on the phase shifter printed circuit boards 342 that serve as input ports thereto. Providing galvanic connections between both the inner and outer conductors of the RF feed cables 390 and the cavity phase shifter assemblies 310A provides a continuous impedance that may result in improved RF performance, and may also eliminate any need to route the RF feed cables 390 to the front side of the reflector 210 (e.g., to a feed board printed circuit board) before electrically connecting to the phase shifter assemblies 340. Use of the cable blocks 380 avoids any need to selectively tin coat the metal shell 320A of cavity phase shifter assembly 310A.

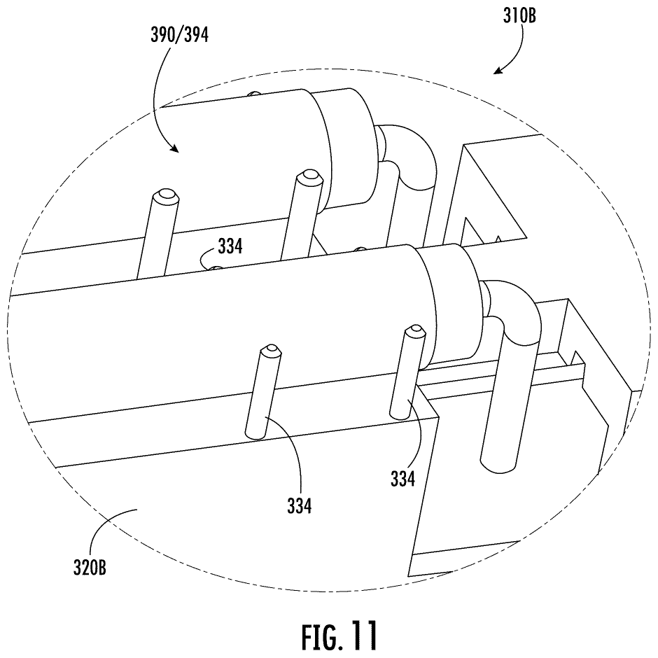

FIG. 11 is an enlarged schematic rear perspective view of a small portion of a cavity phase shifter assembly 310B that may be used in place of the cavity phase shifter 310 of FIGS. 3A-3C. The cavity phase shifter assembly 310B uses metal ground pins 334 that are mounted in the metal shell 320B of the cavity phase shifter assembly 310B to hold the RF feed cables 390 in place and to galvanically connect the outer conductors 394 of the RF feed cables 390 to the metal shell 320B1. As shown in FIG. 11, a plurality of metal ground pins 334 are mounted within respective holes 335 in the rear surface of the metal shell 320B. Each metal ground pin 334 may comprise a metal (e.g., aluminum) pin that is coated with a solderable material (e.g., a tin-coated aluminum pin). The ground pins 334 may be obtained by applying a tin coating to an aluminum rod and then cutting the rod into pieces. The RF feed cables 390 (with the cable jacket thereof removed) may be inserted between one or more pairs of ground pins 334 and solder joints (not shown) may be applied that hold the RF feed cables 390 in place on the metal shell 320B and that galvanically connects the outer conductors 394 of the RF feed cables 390 to the metal shells 320B. The ground pins 334 may provide a very cost-effective solution for galvanically connecting the outer conductors 394 of the RF feed cables 390 to the metal shell 320B. While eight ground pins 334 are shown in FIG. 11, it will be appreciated that a different number of ground pins 334 may be used. In some cases, as few as three ground pins 334 may be used, namely one on the outer side of each RF feed cable 390 and one in between the two RF feed cables 390 that is soldered to the outer conductors 394 of both RF feed cables 390.

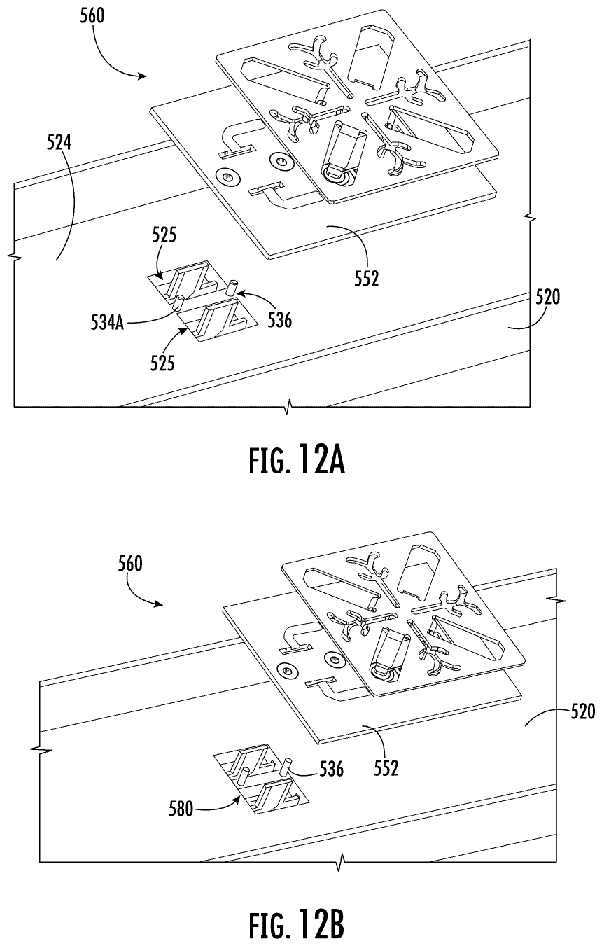

FIGS. 12A and 12B are enlarged schematic exploded front perspective views illustrating how the high-band radiating elements 560 can be galvanically connected to a metal shell 520 of the high-band multi-column array assembly of FIGS. 5A-5B using an interference fit grounding block or interference fit grounding pins. Referring first to FIG. 12A, the dual-polarized patch high-band radiating element 560 of FIG. 6A is mounted on a feed board 552. A pair of openings 525 are formed in the front wall 524 of the metal shell 520 rearwardly of the locations where each high-band radiating element 560 is to be mounted. A pair of forwardly-extending ground pins 534A are provided that are inserted into respective holes 535 in the front wall 524 of the metal shell 520. The ground pins 534A may be identical to the ground pins 534A discussed above with reference to FIGS. 7A-7B and hence are identically numbered. The ground pins 534A may be interference fit into the respective holes 535, and may extend through plated through holes in the feed board 552. Solder joints may be applied to mechanically and electrically attach each ground pin 534A to the feed board 552 so that a galvanic ground connection is provided between the metal shell 520 and the feed board 552. The ground pins 534A may be implemented much more cheaply than the ground pins 534 discussed above with reference to FIGS. 6A-6B as there is no need for a machining operation when ground pins 534A are used.

Referring next to FIG. 12B, a ground pin block 580 is provided that is joined to the metal shell 520. The ground pin block 580 includes a pair of forwardly extending ground pins 534C that serve the same function as ground pins 534A. The ground pin block 580 can be attached to the metal shell 520 by welding or laser soldering. The ground pin block 580 again provides a galvanic electrical connection between the metal shell 520 and the feed board 552.

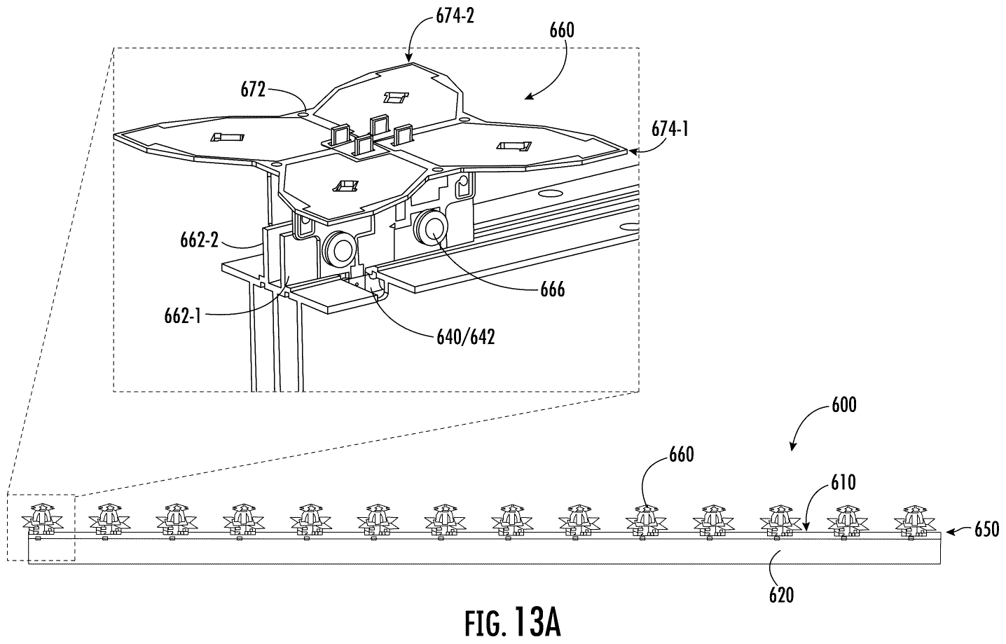

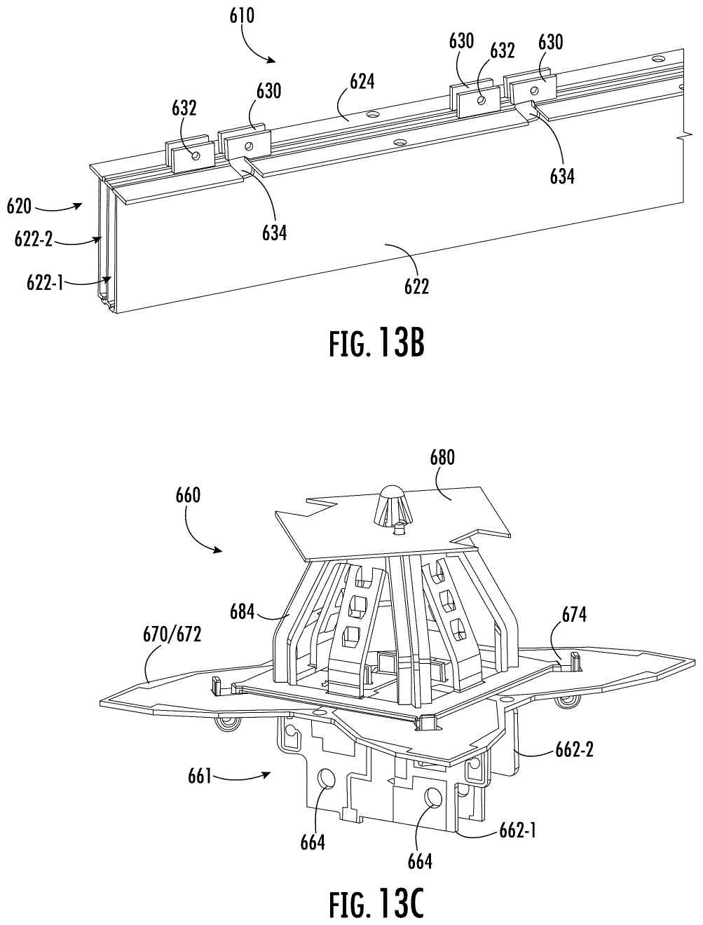

FIG. 13A is a schematic side perspective view illustrating another mid-band linear array assembly 600 that may be used to implement the mid-band linear array assemblies 230 of the base station antenna 200 of FIG. 2. The callout in FIG. 13A is an enlarged perspective view illustrating how one of the mid-band radiating elements 660 connects to the cavity phase shifter assembly 610 of the mid-band linear array assembly 600. FIG. 13B is an enlarged schematic perspective view of a small portion of the cavity phase shifter assembly 610 that is included in the mid-band linear array assembly 600 of FIG. 13A. FIG. 13C is an enlarged schematic perspective view of one of the mid-band radiating elements 660 included in the mid-band linear array assembly 600 of FIG. 13A.

As shown in FIG. 13A, the mid-band linear array assembly 600 includes a cavity phase shifter assembly 610 and a linear array 650 of mid-band radiating elements 660. As discussed above with reference to FIG. 2, the cavity phase shifter assembly 610 is mounted rearwardly of the reflector 210 of base station antenna 200, while the mid-band radiating elements 660 are mounted (at least mostly) in front of the reflector 210. A plurality of openings 216 (see FIG. 2) are provided in the reflector 210 and the feed stalks 662 of the mid-band radiating elements 660 may extend through the openings 216, as will be explained in further detail below. Alternatively, forwardly-extending tabs (not shown) on the phase shifter printed circuit boards 642 of the cavity phase shifter assembly 610 may extend forwardly through the openings 216 in the reflector 210. In either case, the feed stalks 662 are electrically connected to the phase shifter printed circuit boards 642 so that RF signals may be passed between the mid-band radiating elements 660 and the phase shifter printed circuit boards 642. A pair of RF feed cables (not shown) of base station antenna 200 may be electrically connected to the cavity phase shifter assembly 610. These RF feed cables may, for example, be connected to the cavity phase shifter assembly 610 in any of the ways for electrically connecting RF feed cables to a cavity phase shifter assembly that are disclosed herein.

As shown in FIGS. 13A-13B, the cavity phase shifter assembly 610 includes a longitudinally-extending metal shell 620 that has first and second cavities 622-1, 622-2 provided therein. First and second phase shifter assemblies 640 (only a small portion of one of the phase shifter assemblies 640 is visible in FIG. 13A). The first and second phase shifter assemblies 640 may be similar to the first and second phase shifter assemblies 340 that are discussed above and hence further description thereof will be omitted.

As shown in FIG. 13B, a front wall 624 of the metal shell 620 of the cavity phase shifter assembly 610 includes a plurality of sets of four tabs 630 that are transversely and/or longitudinally spaced apart from each other so that the tabs 630 define a rectangle when viewed from the front. One set of tabs 630 may be provided for each mid-band radiating element 660 that is mounted on the metal shell 620. Each tab 630 extends forwardly from the front wall 624 and has major surfaces that extend in the longitudinal and forward directions of the metal shell 620. Each tab 630 includes an opening 632. The metal shell 620 may be formed, for example, by extrusion, and, as extruded, may include a pair of longitudinally-extending walls that extend forwardly from the front wall 624. The tabs 630 may be formed by machining away most of the two walls so that only the tabs 630 remain. The openings 632 may then be formed in the tabs 630 by a punching operation. Openings 634 are formed (e.g., by machining) in the sidewalls 622 of the metal shell 620 directly behind the tabs 630. The openings 634 expose top portions of phase shifter printed circuit boards 642 of the phase shifter assemblies 640. Output ports of the mid-band phase shifter assemblies 640 may be positioned at these locations so that the output ports may be coupled to the mid-band radiating elements 660.

Referring to FIG. 13C, each mid-band radiating element 660 includes a pair of parallel feed stalks 662-1, 662-2 that are implemented using first and second printed circuit boards, a dipole radiator assembly 670 that is implemented as a dipole radiator printed circuit board 672 that includes the dual-polarized dipole radiators 674, a director 680 and a plastic support 684. The dipole radiator assembly 670, the director 680 and the plastic support 684 may be similar or identical to the dipole radiator assembly 470, the director 480 and the plastic support 484 of radiating element 460 of FIG. 4B, and hence further description of these components will be omitted here. Each feed stalk printed circuit board 662 includes a signal trace and a ground trace. As can best be seen in FIG. 13C, a pair of openings 664 are provided in each feed stalk printed circuit board 662.

As shown best in FIG. 13A, each feed stalk printed circuit board 662 may be mounted on and extend forwardly from a respective pair of longitudinally-aligned tabs 630 using, for example, plastic rivets 666 that are inserted through the openings 632 in the tabs 630 and the openings 664 in the feed stalk printed circuit boards 662. A rear edge of each feed stalk printed circuit board 662 may directly contact a forward edge of a respective one of the phase shifter printed circuit boards 642 (e.g., contact an edge of a forwardly-extending tab of the phase shifter printed circuit board 642). A solder joint may be applied that electrically connects a signal trace on each feed stalk printed circuit board 662 to a corresponding output trace on the respective phase shifter printed circuit board 642. The ground traces on the feed stalk printed circuit board 662 are capacitively coupled to the metal shell 620 (e.g., to the tabs 630 on the metal shell 620). In other embodiments, the ground traces on the feed stalk printed circuit boards 662 may be galvanically connected to the metal shell 620 or to ground lines on the phase shifter printed circuit board 642.

The feed stalks 662 of the mid-band radiating elements 660 may be mounted on the metal shell 620 before the mid-band phase shifter assembly 610 is installed in the base station antenna 200. Thus, the performance of the feed stalks 662 may be tested before the base station antenna 200 is assembled (e.g., poor solder joints may be identified before the mid-band phase shifter assembly 610 is installed in the base station antenna 200). In some cases, the dipole radiator printed circuit boards of the mid-band radiating elements 660 may also be temporarily mounted on the feed stalks 662 (but not soldered in place) using a fixture during this pre-assembly testing

The mid-band linear array assembly 600 of FIGS. 13A-13C may have the above-discussed advantages that the mid-band linear array assembly of the base station antenna 400 of FIGS. 4A-4B has over the mid-band linear array assembly of the conventional base station antenna 100 of FIGS. 1A-1B, along with additional advantages. For example, the mid-band linear array assembly 600 of FIGS. 13A-13C does not require feed board printed circuit boards for the mid-band radiating elements 660. This reduces both material costs and the number of soldering operations, and also increases the gain of the mid-band linear array 650 by perhaps 0.1-0.2 dB by eliminating the dielectric and transmission losses in the (omitted) feed board printed circuit boards. In addition, as shown in FIGS. 13A and 13C, the parallel feed stalk printed circuit boards 662 may be placed much close together in the transverse direction than can the crossed feed stalk printed circuit boards included in the mid-band radiating elements 160 of FIGS. 1A-1B. Since the footprint of the feed stalk printed circuit boards 662 is significantly reduced in the transverse direction, the width of the metal shell 620 may be significantly reduced, thereby shrinking the size of the metal shell 620 (e.g., a 25% reduction in size). This may result in material savings and also reduces machining costs.

Referring to FIGS. 2 and 13A-13C, pursuant to embodiments of the present invention, base station antennas are provided that comprise a cavity phase shifter assembly 610 that includes a metal shell 620. The metal shell 620 includes at least a first cavity 622-1 formed therein (and here has two cavities 622-1, 622-2). At least one cross-dipole radiating element 660 is mounted to extend forwardly from the metal shell 620. The cross-dipole radiating element 660 includes a feed stalk 661. The cross-dipole radiating element 660 is mounted on the metal shell 620 using connectors 666 that extend through a first element of the feed stalk 661.

As shown in FIG. 13A, the above-described base station antenna may include a plurality of the cross-dipole radiating elements 660, each of which may have the same design and which may be mounted on the metal shell 620. Each of these cross-dipole radiating elements 660 may comprise a first dipole radiator 674-1 having a first longitudinal axis that extends in a first direction and a second dipole radiator 674-2 having a second longitudinal axis that extends in a second direction that is perpendicular to the first direction. The first longitudinal axis may extend at an angle of +45° with respect to a longitudinal axis of the metal shell 620 when the base station antenna is viewed from the front, and the second longitudinal axis may extend at an angle of −45° with respect to a longitudinal axis of the metal shell 620 when the base station antenna is viewed from the front.

The feed stalk 661 may comprise first and second feed stalk printed circuit boards 662-1, 662-2. The first feed stalk printed circuit board 662-1 may be the above-described first element of the feed stalk 661. The first and second feed stalk printed circuit boards 662-1, 662-2 may extend in parallel to one another, as shown. As shown best in FIG. 13A, the metal shell 620 comprises the front wall 624 and at least first and second tabs 630 that each extend forwardly from the front wall 624. The first feed stalk printed circuit board 662-1 is mounted on the first tab 630 via at least one connector in the form of a plastic rivet 666. The second feed stalk printed circuit board 662-2 similarly is mounted on the second tab 630 via one or more connectors, which again may be in the form of plastic rivets 666. Each tab 630 includes an opening 632 and each feed stalk printed circuit board 662 includes one or more openings 664. Each rivet 666 extends through an opening 664 in one of the feed stalk printed circuit boards 662 and through a mating opening 636 in one of the tabs 630 to mount the first and second feed stalk printed circuit boards 662 to the respective tabs 630. While rivets 666 are shown as exemplary connectors in the figures, it will be appreciated that any appropriate connectors 666 may be used (screws, adhesives, push-pin connectors, etc.).

As shown in FIGS. 13A-13B, the metal shell 620 has first and second cavities 622-1, 622-2 formed therein (i.e., the metal shell 620 defines the first and second cavities 622-1, 622-2). Each cavity 622 may have open ends. First and second cavity phase shifter assemblies 640 are mounted in the respective first and second cavities 622-1, 622-2. The first and second cavity phase shifter assemblies 640 include respective first and second phase shifter printed circuit boards 642. As shown best in the callout in FIG. 13A, a signal trace on the first feed stalk printed circuit board 662-1 is positioned next to an output trace on the first phase shifter printed circuit board 642, and thus the signal trace may be physically and electrically connected to the output trace via a solder joint or other electrical connector (e.g., a capacitive connection). A ground trace on the first feed stalk printed circuit board 662-1 is capacitively coupled to the metal shell 620. The capacitive connection may, for example, be formed through a dielectric substrate of the first phase shifter printed circuit board 642 that capacitively couples the ground trace to, for example, one of the tabs 630, or the ground trace (or at least a portion thereof) may face the tab 630 and be capacitively coupled thereto through, for example, a solder mask that is interposed between the tab 630 and the first phase shifter printed circuit board 642. To facilitate these connections between the feed stalk printed circuit boards 662 and the signal and ground traces on the first phase shifter printed circuit board 642-1, the first feed stalk printed circuit board 662 may be mounted forwardly of the first phase shifter printed circuit board 642 and may be aligned with the first phase shifter printed circuit board 642, as shown in FIG. 13A. Similarly, the second feed stalk printed circuit board 662-2 may be mounted forwardly of and aligned with the second phase shifter printed circuit board (not shown).

Using the mid-band radiating elements 660 shown in FIGS. 13A-13C that are mounted directly to the cavity phase shifter assemblies 610 may provide a number of costs savings. As noted above, this design may allow the feed board printed circuit boards that are typically used to be omitted, which reduces material costs, reduces insertion loss, and eliminates certain soldering operations. In addition, the use of radiating elements having parallel feed stalks allows a reduction in the width of each cavity 662, which saves space within the antenna and further reduces material costs.

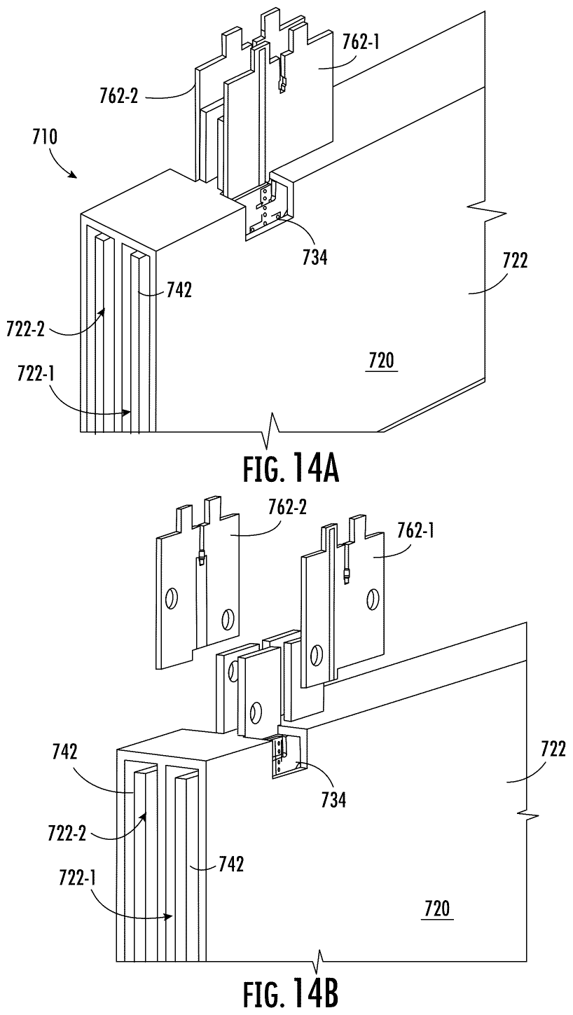

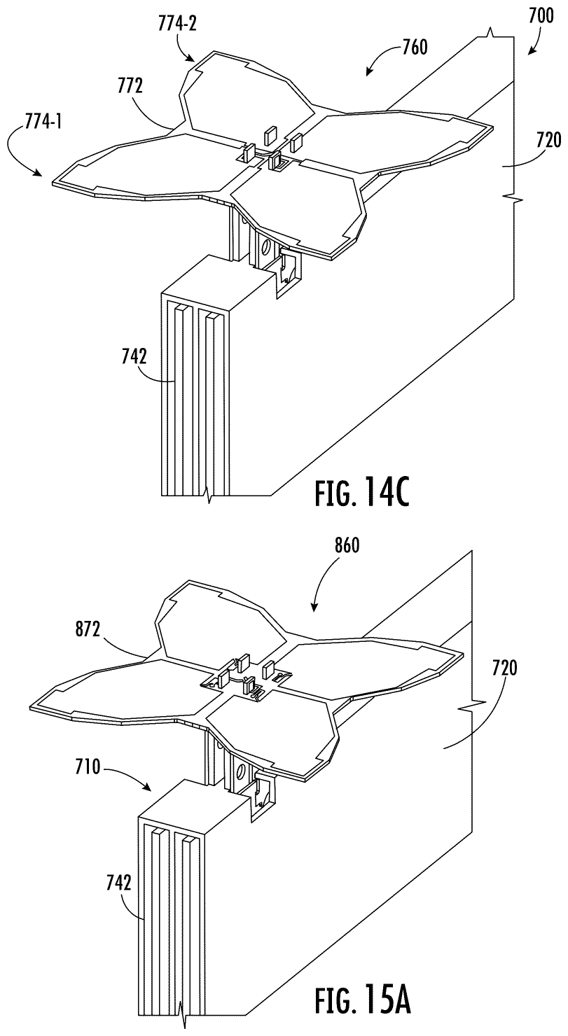

FIGS. 14A-14C illustrate a small, representative portion of yet another mid-band linear array assembly 700 according to embodiments of the present invention that may be used, for example, to implement the mid-band linear array assemblies 230 of the base station antenna 200 of FIG. 2. In particular, FIGS. 14A and 14B are a front perspective view and an exploded front perspective view, respectively, of a cavity phase shifter assembly 710 of the mid-band linear array assembly 700 with the feed stalks 762-1, 762-2 of a mid-band radiating element 760 mounted thereto. The cavity phase shifter assembly 710 includes a metal shell 720 that has first and second cavities 722-1, 722-2 formed therein. The front wall 724 of the metal shell 720 includes four forwardly-extending tabs 730 at each location where a mid-band radiating element 760 is to be mounted. Openings 734 are formed in the sidewalls of the metal shell 720 directly behind the tabs 730 to expose top portions of phase shifter printed circuit boards 742 of the phase shifter assemblies 740. As can be seen, cavity phase shifter assembly 710 may be essentially identical to cavity phase shifter assembly 610, and the feed stalks 762-1, 762-2 of the mid-band radiating element 760 may be mounted on the cavity phase shifter assembly 710 in the same manner that the feed stalks 662-1, 662-2 of mid-band radiating element 660 are mounted on cavity phase shifter assembly 610. Accordingly, further description of FIGS. 14A-14B will be omitted here.

FIG. 14C is a front perspective view of the mid-band linear array assembly 700 of FIGS. 14A-14B with a complete mid-band radiating element 760 mounted thereon. As shown, the mid-band radiating element 760 includes the feed stalk printed circuit boards 762-1, 762-2 that are discussed above, along with a dipole radiator printed circuit board 772. First and second dipole radiators 774-1, 774-2 are formed in the dipole radiator printed circuit board 772, where each dipole radiator 774 comprises a pair of center fed dipole arms. Forwardly extending tabs on the feed stalk printed circuit boards 762 extend through respective openings in the dipole radiator printed circuit board 772 to mount the dipole radiator printed circuit board 772 on the feed stalk printed circuit boards 762-1, 762-2. Solder joints may be applied to electrically connect the signal and ground traces on the feed stalk printed circuit boards 762-1, 762-2 to the four dipole arms included in the first and second dipole radiators 774-1, 774-2.

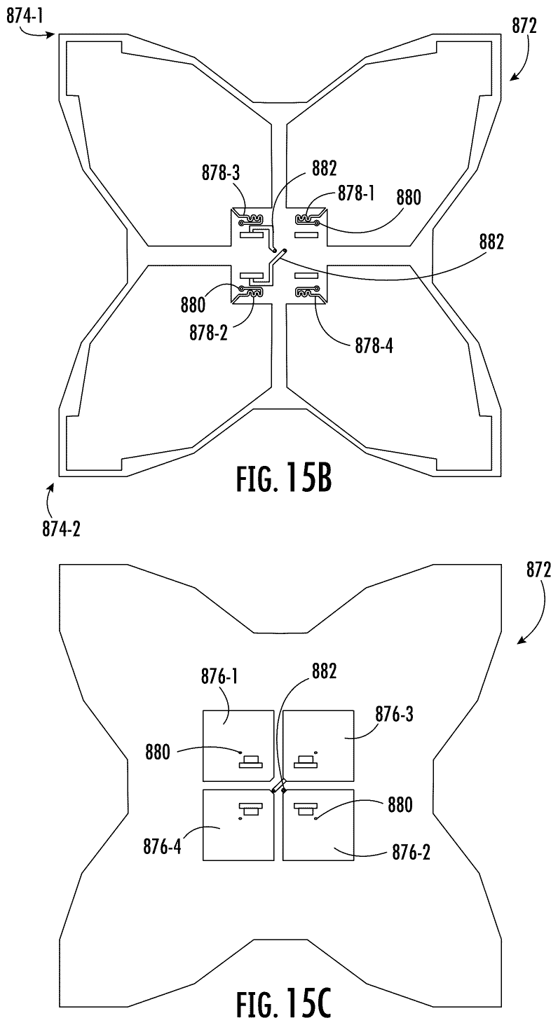

FIGS. 15A-15C illustrate a mid-band radiating element 860 that may be used in place of the mid-band radiating element 760 shown in FIG. 14C. In particular, FIG. 15A is a front perspective view of the cavity phase shifter assembly 710 of FIGS. 14A-14B with the mid-band radiating element 860 mounted thereon. FIGS. 15B and 15C are front and rear views, respectively, of a dipole radiator printed circuit board 872 of the mid-band radiating element 860. The mid-band radiating element 860 may have feed stalks printed circuit boards that are identical to the feed stalk printed circuit boards 662-1, 662-2 of mid-band radiating element 660 so further description thereof will be omitted.

Referring to FIGS. 15A-15C, first and second dipole radiators 874-1, 874-2 arc formed on the front side of the dipole radiator printed circuit board 872. Mid-band radiating element 860 differs from mid-band radiating element 760 in that mid-band radiating element 860 further includes four inductor-capacitor (“LC”) circuit that are integrated into the electrical connections between the signal and ground traces on the feed stalk printed circuit boards and the dipole arms of the first and second dipole radiators 874-1, 874-2. In particular, as shown in FIG. 15C, four metal pads 876-1 through 876-4 are formed on the rear surface of the dipole radiator printed circuit board 872. The signal and ground traces on the feed stalk printed circuit boards may be electrically connected to the four metal pads 876 by, for example, solder joints. Each metal pad 876 overlaps a respective one of the dipole arms to capacitively couple therewith, so that each signal and ground trace on the feed stalk printed circuit boards are capacitively coupled to the respective dipole arms. In addition, four narrow inductive traces 878-1 through 878-4 (which include meandered sections to increase the inductance thereof) are formed on the front side of the dipole radiator printed circuit board 872. Respective plated through holes 880 galvanically connect each narrow inductive trace 878 to a respective one of the dipole arms. Thus, each signal and ground trace on the feed stalk printed circuit boards is coupled to a respective one of the dipole arms through a parallel LC circuit. Additional traces 882 are provided on the dipole radiator printed circuit board 872 and electrically connected through two additional plated through holes 880 to electrically connect the two ground lines on the feed stalk printed circuit boards. The parallel LC circuits may be used to move common mode resonances that otherwise may be induced by the mid-band radiating element 860 in response to RF energy emitted by nearby low-band radiating elements (not shown) outside the operating frequency range of the nearby low-band radiating elements so that the mid-band radiating element 860 does not impact the antenna beams formed by the nearby low-band radiating elements.

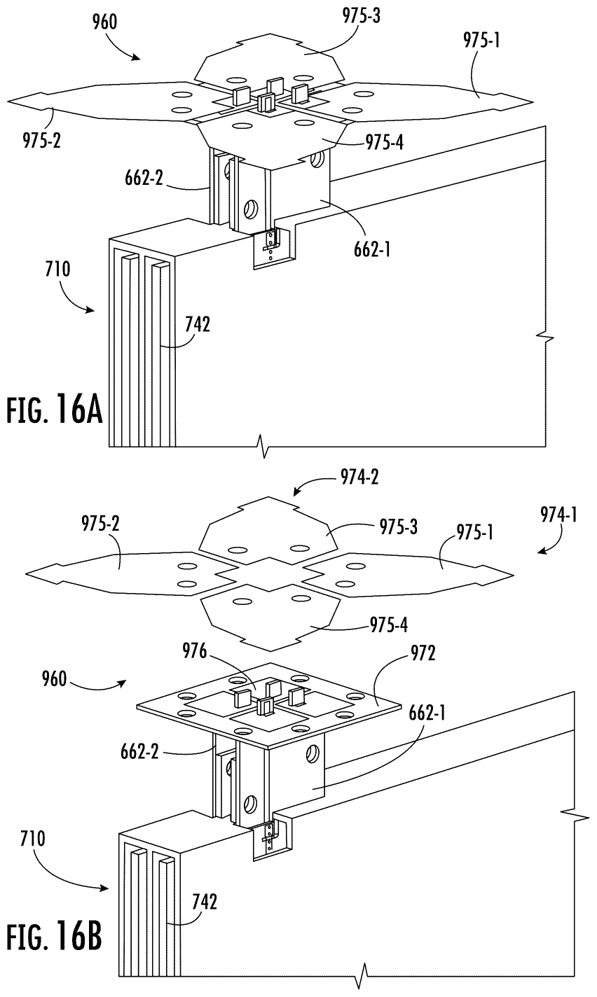

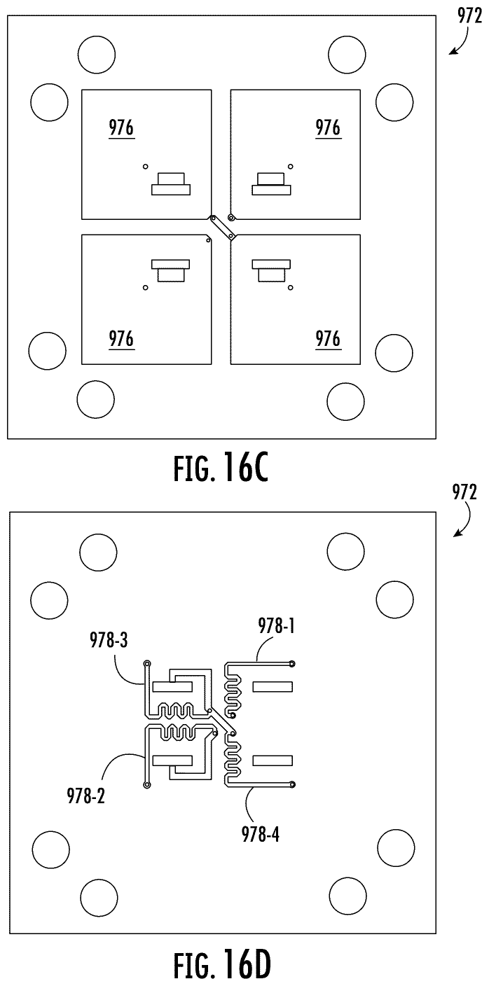

FIGS. 16A-16D illustrate a mid-band radiating element 960 that may be used in place of the mid-band radiating element 760 shown in FIG. 14C. In particular, FIGS. 16A and 16B are a front perspective view and an exploded front perspective view, respectively, of the cavity phase shifter assembly 710 of FIGS. 14A-14B with the mid-band radiating element 960 mounted thereon. FIGS. 16C and 16DC are front and rear views of a dipole radiator printed circuit board 972 of the mid-band radiating element 960. The feed stalks printed circuit boards of mid-band radiating element 960 may be similar or identical to the feed stalk printed circuit boards 662-1, 662-2 of mid-band radiating element 660 so further description thereof will be omitted

Referring first to FIGS. 16A-16B, the mid-band radiating element 960 includes first and second feed stalk printed circuit boards 662-1, 662-2, a small dipole radiator printed circuit board 972, and four sheet metal dipole arms 975-1 through 975-4. Dipole arms 975-1 and 975-2 form a first dipole radiator 974-1 and dipole arms 975-3 and 975-4 form a second dipole radiator 974-2. The small dipole radiator printed circuit board 972 may be mounted on the first and second feed stalk printed circuit boards 662-1, 662-2 in the same manner that the dipole radiator printed circuit board 672 of mid-band radiating element 660 is mounted on the first and second feed stalk printed circuit boards 662-1, 662-2.

Referring to FIGS. 16B and 16C, the small dipole radiator printed circuit board 972 includes four metal pads 976 on a front side thereof. The four sheet metal dipole arms 975 are mounted on the front side of the small dipole radiator printed circuit board 972 and positioned so that a base of each dipole arm 975 overlaps a respective one of the metal pads 976. As shown, cooperating circular openings may be provided in the sheet metal dipole arms 975 and the small dipole radiator printed circuit board 972 so that plastic rivets (not shown) or other connectors may be used to mount each dipole arm 975 on the small dipole radiator printed circuit board 972. It will be appreciated, however, that any appropriate connection mechanism(s) may be used. One or more solder masks or other thin dielectric elements may be positioned between the small dipole radiator printed circuit board 972 and the dipole arms 975 so that the metal pads 976 (which may be galvanically connected to the respective signal or ground traces on the feed stalk printed circuit boards 662-1, 662-2) are capacitively coupled to the respective dipole arms 975.

Referring to FIG. 16D, four narrow inductive traces 978-1 through 978-4 are formed on the rear side of the small dipole radiator printed circuit board 972. The inductive traces 978 are galvanically connected between the respective metal pads 976 and the respective sheet metal dipole arms 975 so that each signal and ground trace on the feed stalk printed circuit boards 662-1, 662-2 is connected to a respective one of the dipole arms 975 through a parallel LC circuit. As the parallel LC circuits have the same general design as the parallel LC circuits of mid-band radiating element 860, further description thereof will be omitted here. The parallel LC circuits may be used to move common mode resonances that otherwise may be induced by the mid-band radiating element 960 in response to RF energy emitted by nearby low-band radiating elements (not shown) outside the operating frequency range of the nearby low-band radiating elements.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A base station antenna, comprising:
a reflector;
a phase shifter that includes a phase shifter printed circuit board; and
a radiating element that includes at least one feed stalk and a radiator mounted on the feed stalk forwardly of the reflector,
wherein the feed stalk is mounted directly on the phase shifter printed circuit board.

2. The base station antenna of claim 1, wherein the phase shifter printed circuit board is mounted rearwardly of the reflector.

3. The base station antenna of claim 2, wherein the reflector includes an opening and the feed stalk extends through the opening.

4. The base station antenna of claim 3, wherein the radiating element is a dual-polarized radiating element, the radiator is a first radiator and the radiating element includes a second radiator, and the feed stalk is implemented using a single printed circuit board that includes first and second RF transmission lines that feed the respective first and second radiators.

5. The base station antenna of claim 3, wherein the radiator comprises a printed circuit board that includes first and second metal pads and a pair of sheet metal dipole arms that are configured to capacitively couple with the respective first and second metal pads.

6. The base station antenna of claim 5, wherein the opening in the reflector is larger than the printed circuit board so that the printed circuit board can be passed through the opening.

7. The base station antenna of claim 1, wherein the phase shifter is part of a cavity phase shifter assembly that further includes a metal shell and the phase shifter printed circuit board is mounted within the metal shell.

8. The base station antenna of claim 7, wherein the feed stalk includes a slot and the phase shifter printed circuit board extends into the slot, wherein the feed stalk is mounted on the phase shifter printed circuit board adjacent an output on the phase shifter printed circuit board, and a solder joint electrically connects the output to a signal trace on the feed stalk.

9. (canceled)

10. The base station antenna of claim 8, wherein a ground pin extends forwardly from the metal shell, and the ground pin is soldered to a ground conductor on the feed stalk.

11. (canceled)

12. The base station antenna of claim 7, wherein the metal shell includes a forwardly extending protrusion that defines an internal channel, and the phase shifter printed circuit board is received within the internal channel and the forwardly extending protrusion includes a gap that exposes the phase shifter printed circuit board, and the feed stalk is mounted on the phase shifter printed circuit board within the gap.

13-14. (canceled)

15. The base station antenna of claim 7, wherein a front wall of the metal shell includes an opening, and the feed stalk extends through the opening.

16. The base station antenna of claim 15, wherein a side wall of the metal shell includes a window that is aligned with the opening in the front wall of the metal shell.

17-18. (canceled)

19. A base station antenna, comprising:
a reflector having an opening; and
a radiating element that includes a feed stalk and a printed circuit board mounted adjacent a forward end of the feed stalk, the printed circuit board extending perpendicular to the feed stalk,
wherein a footprint of the opening is larger than a footprint of the printed circuit board and the opening is aligned with the printed circuit board.

20. The base station antenna of claim 19, wherein the printed circuit board includes first through fourth metal pads, the radiating element further comprising first through fourth sheet metal dipole arms that are mounted on the printed circuit board and configured to capacitively couple with the respective first through fourth metal pads.

21. The base station antenna of claim 20, wherein a footprint of the first through fourth sheet metal dipole arms is larger than the footprint of the opening.

22. The base station antenna of claim 19, further comprising a cavity phase shifter assembly mounted rearwardly of the reflector, the cavity phase shifter including a metal shell and a phase shifter printed circuit board that is mounted within the metal shell.

23. (canceled)

24. The base station antenna of claim 22, wherein the feed stalk extends into a cavity within the metal shell and electrically connects to the phase shifter printed circuit board within the cavity.

25. (canceled)

26. A method of assembling a base station antenna, the method comprising:
forming a metal shell of a cavity phase shifter assembly;
installing a phase shifter within the metal shell;
mounting feed stalks for a plurality of radiating elements on the cavity phase shifter assembly; and then
mounting the cavity phase shifter assembly with the feed stalks mounted thereon behind a reflector with the feed stalks extending through respective openings in the reflector; and then
mounting radiators on the respective feed stalks.

27. The method of claim 26, the method further comprising:
mounting respective printed circuit boards that each include a plurality of metal pads on the respective feed stalks prior to mounting the cavity phase shifter assembly with the feed stalks mounted thereon behind the reflector; and
mounting a plurality of sheet metal dipole arms on each printed circuit board after mounting the cavity phase shifter assembly with the feed stalks mounted thereon behind the reflector.

28. The method of claim 27, wherein footprints of the openings in the reflector are larger than footprints of the printed circuit boards and the openings are aligned with the printed circuit boards.

29-81. (canceled)
